(19) United States
(12) Patent Application Publication
(10) Pub. No.: US 2026/0108869 A1
(43) Pub. Date: Apr. 23, 2026

(54) CATALYSTS AND PROCESSES FOR STEREOSELECTIVE RING-OPENING POLYMERIZATION

(71) Applicant: Technische Universität München, München (DE)

(72) Inventors: Jonas BRUCKMOSER, Garching (DE); Bernhard RIEGER, Garching (DE)

(21) Appl. No.: 19/117,606

(22) PCT Filed: Sep. 26, 2023
(86) PCT No.: PCT/EP2023/076568

§ 371 Date: Apr. 1, 2025

(30) Foreign Application Priority Data
Oct. 6, 2022 (EP) 22199920.4
Feb. 17, 2023 (EP) 23157166.2

(51) Int. Cl. B01J 31/22; C08G 63/08

(52) U.S. Cl. CPC B01J 31/2217; C08G 63/08; B01J 2231/48; B01J 2531/36; B01J 2531/37; B01J 2531/38

(57) ABSTRACT

Provided is a chelate complex comprising (a) a rare earth metal cation M; (b) a chelate ligand of formula (CL1 A) or (CL1 B) c) at least one anionic nucleophilic ligand LN which is coordinated as a further ligand to the rare earth metal cation; and d) optionally one or more neutral donor ligands LD coordinated as ligands to the rare earth metal cation. Moreover, provided are a process for the preparation of a chelate complex, a process for the preparation of a polymer comprising a polymerization reaction of chiral cyclic ester monomers, and a poly(3-hydroxy butyrate) polymer which can be provided by the process.

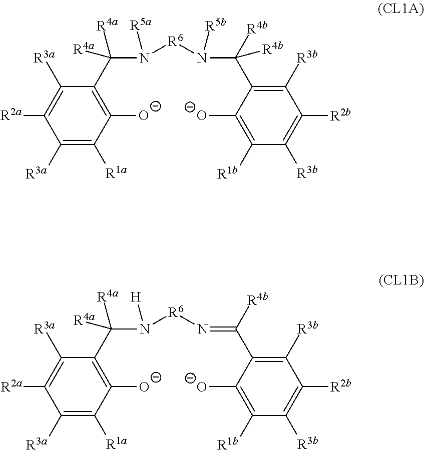

The present invention relates to catalysts for the stereoselective ring-opening polymerization (ROP) of chiral cyclic esters, and to processes for the preparation of polymers using chiral cyclic esters as monomers.

Polyhydroxyalkanoates (PHAs) are an intriguing class of biodegradable, aliphatic polyesters that are naturally produced by a various number of microorganisms and have attracted considerable research attention due to promising applications in the biomedical, pharmaceutical and packaging sector.¹ The most extensively studied PHA is poly(3-hydroxybutyrate) (PHB), naturally existing strictly in its (R)-configuration as isotactic, crystalline thermoplastic material. Its properties resemble those of isotactic polypropylene (i-PP) regarding Young's modulus, tensile strength and impact strength as well as resistance against UV radiation and high oxygen barrier, demonstrating the vast potential of PHB as a commodity plastic.² However, considering the substitution of i-PP by PHB, several challenges remain unresolved. In contrast to i-PP, perfectly isotactic PHB (bacterial (R)-PHB) is brittle and has a high melting temperature near the decomposition temperature, rendering its processing difficult. It has been shown that the degree of isotacticity is correlating with the crystallinity as well as the melting temperature of PHB.³ The degree of isotacticity is given by the Pₘ value, where Pₘ is the probability of meso linkages in the polymer chain (for perfectly isotactic PHB Pₘ=1.00). Reducing the isotacticity of the polymer from Pₘ=1.00 to Pₘ=0.74 resulted in a decrease of the melting temperature from 177° C. to 110° C. and thus, melt processing of PHB with lowered isotacticity is in general feasible.⁴ Additionally, reducing the crystallinity generally reduces the brittleness of polymers, and increases the rate of biodegradation in the specific case of PHB.⁴, 5 On the other hand, a melting temperature close to 100° C. may be disadvantageous in certain applications of the polymer, so that an optimization of the isotacticity is desirable.

Concerning the synthesis pathways for PHB, a fermentative production starting from feedstocks such as sugar or starch could be acheived², but the extraction of PHB results in a high-priced product. Further, the perfect isotacticity of bacterial (R)-PHB (Pₘ=1.00) leads to a material with inferior properties compared to i-PP or PHB with reduced isotacticity. Another route towards PHB is the polycondensation approach, however, harsh polymerization conditions and low control over the polymerization (resulting in low molecular weights and broad dispersities of the polymers) constitute severe drawbacks.⁶ Keeping this in mind, the most promising route towards PHB is the chemical synthesis via ring-opening polymerization (ROP) of β-butyrolactone (BBL) promoted by organometallic catalysts as shown in the following Scheme 1A.² Since BBL is a readily available monomer which is obtained by carbon monoxide insertion into propylene oxide, this route can be realized from established fossil fuel-based chemistry.⁷ The CO₂-based propylene production via methanol shown in Scheme 1 B is a valuable, sustainable alternative towards PHB.^{2, 8, 9}

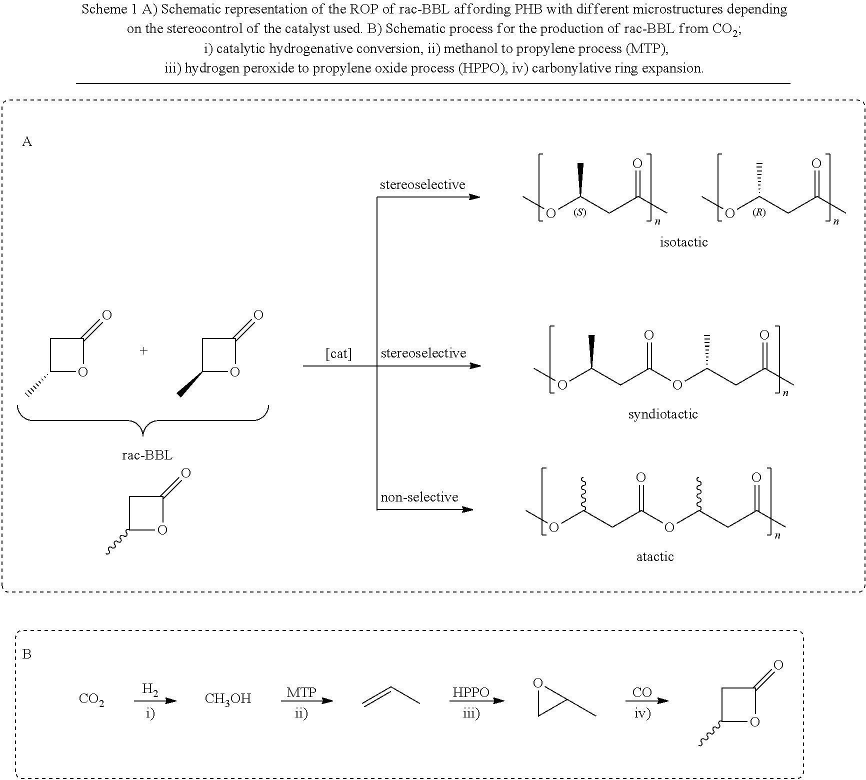

Considering the above-mentioned correlation of the polymer's properties and its microstructure, controlling the degree of tacticity is crucial. Perfectly isotactic PHB can be obtained by the use of enantiopure BBL and reducing the degree of tacticity can be achieved by adjusting the ratio of enantiopure (R)- and (S)-BBL content in the monomer feed.^{10, 11} However, with regard to a cost-efficient approach towards PHB synthesis, the use of racemic (rac) BBL as feedstock is advantageous. In order to control the microstructure of the polymer, a stereoselective process is required. ROP of rac-BBL can afford PHB with various degrees of isotacticity or syndiotacticity if the catalyst enables a stereocontrolled ROP. In metal-mediated coordination-insertion ROP two general types of stereocontrol exist: i) the chain-end control mechanism where the chirality of the last inserted monomer determines the chirality of the next monomer to be incorporated and ii) the enantiomorphic site-control mechanism where the chirality of the catalyst determines the enantiomer which is inserted next.¹² Similarly to the degree of isotacticity Pₘ, the degree of syndiotacticity is given by the Pᵣ value, where Pᵣ is the probability of racemic linkages in the polymer chain. Both values can be used independently to describe the tacticity of the polymer and the correlation of those two values is Pₘ=1−Pᵣ.

For perfectly syndiotactic PHB Pᵣ=1.00. In the case that the ROP of rac-BBL is not stereocontrolled, an atactic PHB is obtained, which shows inferior mechanical properties due to its amorphic nature (for atactic PHB Pₘ=Pᵣ=0.50).

Various metal catalysts including Mg, Al, In, Sn, Cr, Zn and rare-earth metals were found to be efficient initiators for the ROP of rac-BBL.¹³⁻¹⁶ Catalysts for the stereocontrolled ROP have been recently reviewed by Thomas and Carpentier et al.¹⁴⁻¹⁶ Among these, rare-earth metal catalysts, especially yttrium-based catalysts, are most active and allow for precise control of molecular weights, dispersity, end-group fidelity as well as stereoselectivity under mild conditions.¹⁷ Carpentier et al. introduced a class of yttrium catalysts supported by tripodal tetradentate aminoalkoxy-bis(phenolate) [ONXO^{R1,R2}](X═NR₂, OR) ligands showing excellent activity in the ROP of rac-BBL (TOF up to 24 000 h⁻¹).¹⁸ Extensive research over the last decade focused on fine-tuning of catalysts including a rare-earth metal center, substitutions at the phenolic ortho- and para-positions (R¹, R²), different X donor ligands as well as various nucleophilic initiator ligands.¹⁹ Catalysts based on mid-sized metal centers (Y, Lu) turned out to be most active and the ortho-position on the phenolate is crucial for obtaining a high stereoselectivity. Increasing the steric demand of the ortho-substituents from tert-butyl<cumyl<trityl resulted in an increase of the observed syndiotacticity of polymers (Pᵣ=0.80, 0.91, 0.96, respectively).²⁰ Using this class of aminoalkoxy-bis(phenolate) catalysts, only PHB with an atactic, syndio-enriched or syndiotactic microstructure has been reported so far. Various other catalyst systems for the production of syndio-enriched or syndiotactic PHB have been reported to date.¹⁴⁻¹⁶ In contrast to isotactic PHB, however, syndiotactic and atactic PHB are not biodegradable⁴, and the melting temperature of syndiotactic PHB is slightly higher than that of perfectly isotactic PHB.²¹

Examples of catalysts inducing isotacticity in the ROP of rac-BBL remain scarce. Early work in the 1970s by Agostini, Tani and others showed that partially hydrolyzed aluminum alkyl species produce PHB with a minor fraction of iso-enriched polymer (Pₘ˜0.8) and a major atactic fraction.²²⁻²⁸ The tacticity of the crude (unfractionated) polymer was up to Pₘ=0.65.²¹ Besides yielding mixtures of PHB products (most likely due to the ill-defined nature of the diverse catalytically active species), long reaction times are generally required to achieve high conversions. Spassky et al. reported the synthesis of iso-enriched PHB using a catalyst system of ZnEt₂ with (R)-3,3-dimethylbutane-1,2-diol.²⁹ However, the product also consisted of a mixture of methanol-soluble atactic and insoluble (˜25%) iso-enriched (Pₘ˜0.8) fractions. In 2008, Rieger and co-workers were able to produce high molecular weight, iso-enriched PHB (0.60<Pₘ<0.70) from rac-BBL using a chromium(III) salophen complex.³⁰ WO 2006/108829 A2 relates to the use of these catalysts in ROP.³¹ In comparison to naturally produced PHB the melting transition temperature could be significantly lowered (Tₘ˜180° C. vs. Tₘ˜120, 145° C.) and thus, allows for melt processing without decomposition of the material. Investigations on the electronic influences of the phenylene backbone showed that halogen atoms considerably increase the activity whereas alkyl groups render the complex almost inactive.^{30, 32} However, TOFs were relatively low (<162 h⁻¹) and dispersities of the polymers were severely broadened (Ð>5.2) albeit high molecular weight could be obtained (M_{w}>186 kg mol⁻¹). Using a different approach, Thomas and Gauvin et al. were able to obtain iso-enriched PHB (Pₘ=0.85) from rac-BBL by grafting [Nd(BH₄)₃(THF)₃] onto silica.^{33, 34} This heterogeneous catalyst shows the highest isoselectivity in ROP of rac-BBL reported to date. Major drawbacks of this catalyst system are the relatively low molecular weight of the PHB obtained (Mₙ=11.5 kg mol⁻¹, Ð=1.18) and the low activity (TOF=6 h⁻¹). Yao et al. reported the stereoselective switchable ROP of rac-BBL by yttrium(III) and ytterbium(III) salan complexes.³⁵ By changing the substituents on the bridging amine of the ligand framework from aromatic phenyl to aliphatic cyclohexyl groups, a switch in stereoselectivity from iso-enriched (Pₘ=0.66-0.72) to syndio-enriched (Pₘ=0.22-0.23) PHB was possible. At a polymerization temperature of 0° C., the isoselectivity of the phenyl-substituted Yb(III) salan complex could be slightly increased (Pₘ=0.77). TOFs of isoselective catalysts were in the range of 5 to 26 h⁻¹. Recently, a lanthanum catalyst supported by a tridendate amino-bis(phenolate) ligand framework was reported by Robinson et al.^{36, 37} In the absence of additional donor ligands, the catalyst showed only poor isoselectivity and activity in the ROP of rac-BBL (Pₘ=0.57, TOF=42 h⁻¹). However, when adding two equivalents of neutral donor ligands to the catalyst system in situ, the isoselectivity could be increased up to Pₘ=0.75 at room temperature. Additionally, the activity of the catalyst was increased (TOF up to 1900 h⁻¹). Performing the polymerization at 0° C. or −30° C. could further enhance the isoselectivity to Pₘ=0.82. Donor ligands are of the class of tertiary amines, pyridines, phosphines, phosphoxides or N-oxides. The patent application US2021/0188878 A1 has been filed by the authors.³⁸ Another patent application WO 2019/120846 A1³⁹ describes the preparation of a catalytically active species in situ by combining a chiral BINOL-Box ligand with an yttrium complex precursor. However, high dispersities of the polymers were observed and the activity of this catalyst system is limited (TOF<117 h⁻¹).

Considering the synthesis of rac-BBL from propylene oxide, approaches of tandem catalysis exist, where the carbonylation of rac-propylene oxide to rac-BBL and subsequent ROP towards PHB is carried out in a one-pot approach.⁴⁰ Similarly, the alternating copolymerization of propylene oxide with carbon monoxide yields PHB.^{41, 42} Isotactic PHB can be accessed with these approaches when enantiomerically pure propylene oxide is used, however, comparable to the use of enantiomerically pure BBL, such approaches are not cost-efficient.

An alternative route towards isotactic PHB has been described by Chen and co-workers using an eight-membered rac-diolide, which is a cyclic dimer of 3-hydroxybutyric acid, as monomer for the production of PHB instead of using rac-BBL (the monomer of 3-hydroxybutyric acid).⁴³ La(N(SiMe₃)₂)₃ and yttrrium(III) aminoalkoxy-bis(phenolate) catalysts rendered PHB with modest isoselectivities (Pₘ=0.70-0.76) whereas the use of yttrium(III) salen-based catalysts gave access to perfectly isotactic PHB (Pₘ>0.99). Additionally, these catalysts were able to perform kinetic resolution polymerizations, where the enantiomerically pure salen catalysts with cyclohexyl backbones (S,S or R,R) polymerized the contrary enantiomer of diolide, i.e. R,R or S,S and left the other enantiomer untouched. Using a mixture of rac- and meso-diolide, stereosequenced PHB with gradual alteration from isotactic block to syndiotactic block could be obtained.⁴⁴ Although the stereocontrol in the ROP of diolide using these rare-earth metal-based catalysts is outstanding, the elaborate multi-step synthesis of the monomer and the separation of rac- and meso-diolide hamper commercialization. The approach of using eight-membered instead of four-membered cyclic esters to access PHB has also been extended to monomers with different pendant side chains in order to obtain diverse, isotactic polyhydroxyalkanoates.^{45, 46} Two patent applications have been filed by the authors (US2019/0211144 A1; US2021/0206912 A1).^{47, 48} Functional isotactic polyhydrohyalkanoates were also accessible by ROP of 4-alkoxymethylene-β-propiolactones⁴⁹, involving a sophisticated monomer synthesis.

The most convenient route towards PHB is the chemical synthesis starting from rac-BBL. This monomer can be derived from abundant propylene oxide and carbon monoxide, rendering its synthesis economically as well as atom-economically highly appealing. Current homogenous catalytic systems for the ROP of rac-BBL achieve only relatively low isoselectivity at room temperature or above. Additionally the catalytic activity for an industrial process leaves room for improvement, and especially the controlled production of high molecular weight, iso-enriched PHB remains a problem to be solved.

The present invention provides catalysts that can be used for a stereoselective ring-opening polymerization reaction (ROPs) of chiral cyclic esters. The catalysts comprise a metal center, and bear a salan-type or salalen-type ligand framework and at least one anionic nucleophilic ligand. The catalysts can be isolated prior to their use in a polymerization reaction, but can also be prepared in situ without the need of isolation, and the monomer can be added directly to the reaction mixture for an efficient polymerization process. The catalysts achieve high activity and stereocontrol in the ROP of racemic β-butyrolactone (rac-BBL). By varying the substituents of the ligand framework, highly syndiotactic or highly isotactic poly(3-hydroxybutyrate) can be obtained from rac-BBL.

In line with the above, the invention provides, as a first aspect (aspect 1), a chelate complex comprising:
a) a rare earth metal cation M;
b) a chelate ligand of formula (CL1A) or (CL1B)

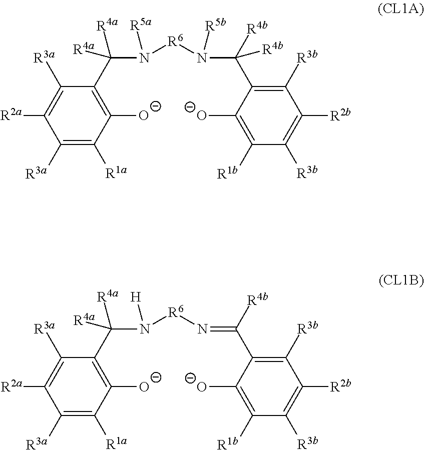

wherein
the chelate ligand is coordinated via the two nitrogen atoms and the two oxygen atoms shown in the formulae to the rare earth metal cation,
R^{1a} and R^{1b} independently represent a sterically demanding group comprising 6 or more skeleton atoms, preferably 6 or more skeleton atoms selected from carbon, silicon, oxygen and nitrogen, and more preferably 6 or more carbon atoms optionally in combination with other types of skeleton atoms, and optionally, R^{1a} and R^{1b} may be linked to each other to provide a divalent organic residue,
R^{2a} and R^{2b} are independently selected from hydrogen, C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} (where R^{S9} and R^{S10} (are independently selected from C1-C5 alkyl), a group of the formula (S-1)

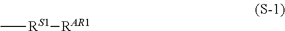

wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted, and a group of the formula (S-2) RAM RAR3 (S-2)

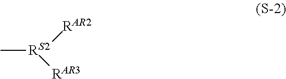

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted,
R^{3a} and R^{3b} are, independently for each occurrence, selected from hydrogen, C1-C10 alkyl, halogen (such as F, C and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} (where R^{S9} and R^{S10} are independently selected from C1-C5 alkyl),
R^{4a} and R^{4b} are selected, independently for each occurrence, from hydrogen, C1-C3 alkyl, halogen (such as F, Cl or Br), —NO₂, —CN, C1-C3 haloalkyl (such as fluoroalkyl) and C1-C3 alkoxy,
R^{5a} and R^{5b} are independently selected from hydrogen, alkyl, cycloalkyl and phenyl, with the proviso that one of R^{5a} and R^{5b} must be hydrogen,
R⁶ is selected from a C2-C5 alkanediyl, a C2-C5 alkenediyl and a C2-C5 alkynediyl group, preferably from a C2-C3 alkanediyl, a C2-C3 alkenediyl and a C2-C3 alkynediyl group and is more preferably C2-C3 alkanediyl,
wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} (where R^{S9} and R^{S10} are independently selected from C1-C5 alkyl), and/or two substituents R^{S11}, e.g substituents R^{S11} attached to adjacent carbon atoms of the alkanediyl, alkenediyl or alkynediyl group, may be linked to form, together with the atoms to which they are attached, a 5 to 14 membered carbocyclic or heterocyclic group which is optionally substituted by one or more further substituents;
c) at least one anionic nucleophilic ligand L^{N} which is coordinated as a further ligand to the rare earth metal cation; and
d) optionally one or more neutral donor ligands L^{D} coordinated as ligands to the rare earth metal cation.

In accordance with usual practice, the reference herein to any organic group or residue as a CX to CY organic group or residue, with X and Y being integers of 1 or more, indicates that the organic group or residue contains from X to Y carbon atoms.

Also in accordance with the common practice in the art, the reference to a cyclic group, such as an aryl group or a heteroaryl group, as being an X membered group or a X to Y membered group, with X and Y being integers of 1 or more, indicates the number of ring members of the group as being X or as being from X to Y, respectively. As will be understood by the skilled reader, the ring members of an aryl group are carbon atoms, whereas a heteroaryl group also comprises ring members other than carbon atoms, such as N or O. Unless indicated to the contrary, and if the number of ring members allows, a cyclic group, such as an aryl group, can be formed by one single ring, or can be formed by two or more anellated rings.

Furthermore, it will be understood that the definitions of variables which occur in formula (CL1A) an (CL1B), such as R^{1a} to R^{3a} and R^{1b} to R^{3b}, apply for both formulae, whereas definitions of variables which occur only in formula (CL1A) apply only for formula (CL1A), such as R^{5a} and R^{5b}.

The rare earth metal providing the rare earth metal cation, referred to as M, of the chelate complex, is selected from scandium (Sc), yttrium (Y), and a lanthanoid metal, i.e. a metal with an atomic number in the periodic table of the elements of 57 to 71. Preferably, the rare earth metal is selected from Y, Yb, La and Lu. Still more preferably, it is selected from Y, Yb and Lu, and most preferably it is selected from Y and Lu. The rare earth metal cation is preferably a three-valent cation, which applies as well for the preferred species Y³⁺, Yb³⁺, La³⁺ and Lu³⁺ and their more preferred forms, so that most preferred as the rare earth metal cation are Y³⁺ and Lu³⁺.

The chelate complex in accordance with the invention is typically a mononuclear complex, i.e. a complex comprising a single metal coordination center.

R^{1a} and R^{1b} independently represent a sterically demanding group comprising 6 or more skeleton atoms. Preferably, each of R^{1a} and R^{1b} comprises 6 or more skeleton atoms selected from carbon, silicon, oxygen and nitrogen, and more preferably 6 or more carbon atoms, optionally in combination with other types of skeleton atoms. Optionally, R^{1a} and R^{1b} may be linked to each other to provide a divalent organic residue.

As used herein, the term “skeleton atom” refers to an atom forming a covalent bond to at least two adjacent atoms. The number of skeleton atoms in each of R^{1a} and R^{1b} is preferably 35 or less.

Preferred as a sterically demanding group is a group which comprises 6 or more skeleton atoms, including at least one of:
(i) a tertiary carbon atom or silicon atom acting as a point of attachment of the group R^{1a} or R^{1b}, respectively, to the phenyl ring carrying the group;
(ii) a quaternary carbon atom or silicon atom; and
(iii) 5 or 6 of the skeleton atoms in the form of a 5- or 6-membered carbocycle or heterocycle.

It will be understood that the tertiary carbon or silicon atom referred to in (i) above, the quaternary carbon or silicon atom referred to in (ii) above and the 5 or 6 skeleton atoms referred to in (iii) above would be considered as forming part of the 6 or more skeleton atoms of the sterically demanding group. For example, the heterocycle may be a heterocycle containing one or two heteroatoms selected from N and O, the remaining ring atoms being carbon atoms.

As used herein, a tertiary carbon atom acting as a point of attachment of the group R^{1a} or R^{1b}, respectively, to the phenyl ring carrying the group is a carbon atom which forms three covalent bonds to three adjacent carbon atoms, and one covalent bond to the phenyl ring carrying the group. Likewise, a tertiary silicon atom acting as a point of attachment of the group R^{1a} or R^{1b}, respectively, to the phenyl ring carrying the group is a silicon atom which forms three covalent bonds to three adjacent carbon atoms, and one covalent bond to the phenyl ring carrying the group.

More preferably, R^{1a} and R^{1b} are independently selected from the following options (i) to (iii).
(i) A branched C6 to C15 alkyl group comprising at least one of a tertiary and a quaternary carbon atom or a branched C6 to C15 alkoxy group comprising at least one of a tertiary and a quaternary carbon atom, which branched alkyl group and branched alkoxy group is optionally substituted. The one or more optional substituents are preferably selected independently from C2-C5 alkenyl, C2-C5 alkynyl, halogen (such as F, Cl or Br), —NO₂, —CN, and —NR^{S9}R^{S10} where R^{S5} and R^{S10} are independently selected from C1-C5 alkyl.
(ii) A group of the formula (S-1):

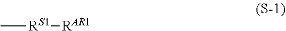

wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted.
(iii) A group of the formula (S-2)

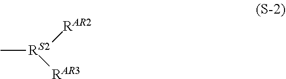

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted.

Among option (i) (the branched C6 to C15 alkyl group or branched C6 to C15 alkoxy group comprising at least one of a tertiary and a quaternary carbon atom), option (ii) (the group of formula (S-1)) and option (iii) (the group of formula (S-2)), options (ii) and (iii) are preferred for R^{1a} and R^{1b}.

The optionally substituted divalent alkyl group and the optionally substituted —O—C1-C8 divalent alkyl group in formula (S-1) can be substituted by one or more substituents preferably selected independently from C2-C5 alkenyl, C2-C5 alkynyl, halogen (such as F, Cl or Br), —NO₂, —CN, and —NR^{S9}R^{S10} where R^{S9} and R^{S10} are independently selected from C1-C5 alkyl. As will be understood by the skilled reader, the optional substituents would be attached to R^{S1} in addition to the mandatory substituent R^{AR1}. R^{S1} in formula (S-1) is preferably a divalent alkyl group which is optionally substituted.

The optionally substituted trivalent alkyl group and the optionally substituted —O—C1-C5 trivalent alkyl group in formula (S-2) can be substituted by one or more substituents preferably selected independently from C2-C5 alkenyl, C2-C5 alkynyl, halogen (such as F, Cl or Br), —NO₂, —CN, and —NR^{S9}R^{S10} where R^{S9} and R^{S10} are independently selected from C1-C5 alkyl. As will be understood by the skilled reader, the optional substituents would be attached to R^{S2} in addition to the mandatory substituents R^{AR2} and R^{AR3}, R^{S2} in formula (S-2) is preferably a trivalent alkyl group which is optionally substituted.

The optionally substituted phenyl group and the optionally substituted heteroaryl group in formula (S-1) and formula (S-2) can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl. Examples of the heteroaryl group are groups containing one or two heteroatoms selected from O and N as ring members, the remaining ring members being carbon atoms.

Still more preferably, R^{1a} and R^{1b} are independently selected from:
(i) a group of the formula (S-3):

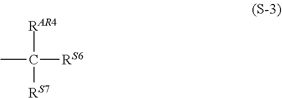

wherein R^{S6} and R^{S7} are independently selected from H and C1-C3 alkyl, preferably from H and methyl, and are preferably both methyl, and R^{AR4} is a phenyl group which is optionally substituted; and
(ii) a group of the formula (S-4):

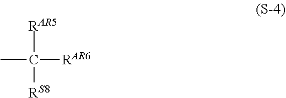

wherein R^{S6} is selected from H and C1-C3 alkyl, preferably from H and methyl, and is preferably methyl; and R^{AR5} and R^{AR6} are independently a phenyl group which is optionally substituted.

The optionally substituted phenyl groups in formula (S-3) and formula (S-4) can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.

R^{2a} and R^{2b} are independently selected from hydrogen, C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} (where R^{S9} and R^{S10} are independently selected from C1-C5 alkyl), a group of the formula (S-1) as defined above and a group of the formula (S-2) as defined above.

The optionally substituted aryl group, the optionally substituted heteroaryl group, and the respective groups in the aryloxy and the heteroaryloxy groups can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl. Examples of the heteroaryl group are groups containing one or two heteroatoms selected from O and N as ring members, the remaining ring members being carbon atoms.

Preferably, R^{2a} and R^{2b} are independently selected from H, a C1-C20 alkyl group, a group of the formula (S-3) as defined above and a group of the formula (S-4) as defined above. More preferably, R^{2a} and R^{2b} are independently selected from H, a branched C4 to C6 alkyl group comprising at least one of a tertiary and a quaternary carbon atom, a group of the formula (S-3) as defined above and a group of the formula (S-4) as defined above. Still more preferably, R^{2a} and R^{2b} are independently selected from a branched C4 to C6 alkyl group comprising at least one of a tertiary and a quaternary carbon atom, a group of the formula (S-3) as defined above and a group of the formula (S-4) as defined above.

In line with the above, it will be understood that a strongly preferred combination of R^{1a}, R^{1b}, R^{2a} and R^{2b} is provided if R^{1a} and R^{1b} are independently selected from a group of the formula (S-3) as defined above and a group of the formula (S-4) as defined above, and R^{2a} and R^{2b} are independently selected from a branched C4 to C6 alkyl group comprising at least one of a tertiary and a quaternary carbon atom, a group of the formula (S-3) as defined above and a group of the formula (S-4) as defined above.

R^{3a} and R^{3b} are, independently for each occurrence, selected from hydrogen, C1-C10 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} (where R^{S9} and R^{S10} are independently selected from C1-C5 alkyl). Preferably, R^{3a} and R^{3b} are hydrogen.

As underlined above, the groups R^{3a} are selected from the above options independently for each occurrence, i.e. the two groups R^{3a} attached to one of the phenyl rings shown in the above formulae can be identical or different. Likewise, the two groups R^{3b} attached to the other phenyl ring shown in the above formulae can be identical or different.

The optionally substituted aryl group, the optionally substituted heteroaryl group, and the respective groups in the aryloxy and the heteroaryloxy groups can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl. Examples of the heteroaryl group are groups containing one or two heteroatoms selected from O and N as ring members, the remaining ring members being carbon atoms.

R^{4a} and R^{4b} are, independently for each occurrence, selected from hydrogen, C1-C3 alkyl, halogen (such as F, Cl or Br), —NO₂, —CN, C1-C3 haloalkyl (such as fluoroalkyl) and C1-C3 alkoxy. Preferably, R^{4a} and R^{4b} are hydrogen.

As underlined above, the groups R^{4a} are selected from the above options independently for each occurrence, i.e. the two groups R^{4a} attached to the same carbon atom shown in the above formulae can be identical or different. Likewise, two groups R^{4b} attached to the same carbon atom shown in the above formula (CL1A) can be identical or different.

Generally, neither one of the groups R^{1a}, R^{2a}, R^{3a} and R^{4a} or R^{1b}, R^{2b}, R^{3b} and R^{4b} forms a bond with the rare earth metal cation, or with another metal center. Preferably, the chelate ligand of formula (CL1A) or (CL1B) is a ligand which forms four bonds with the rare earth metal cation.

R^{5a} and R^{5b} are independently selected from hydrogen, alkyl, cycloalkyl and phenyl, with the proviso that one of R^{5a} and R^{5b} must be hydrogen. The alkyl is preferably C1 to C6 alkyl, and the cycloalkyl is preferably cyclohexyl. It is particularly preferred that both of R^{5a} and R^{5b} are hydrogen.

R⁶ is selected from a C2-C5 alkanediyl, a C2-C5 alkenediyl and a C2-C5 alkynediyl group, preferably from a C2-C3 alkanediyl, a C2-C3 alkenediyl and a C2-C3 alkynediyl group and is more preferably C2-C3 alkanediyl,
wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} (where R^{S9} and R^{S10} are independently selected from C1-C5 alkyl), and/or two substituents R^{S11}, e.g substituents R^{S11} attached to adjacent carbon atoms of the alkanediyl, alkenediyl or alkynediyl group, may be linked to form, together with the atoms to which they are attached, a 5 to 14 membered carbocyclic or heterocyclic group which is optionally substituted by one or more further substituents.

The optionally substituted aryl group, the optionally substituted heteroaryl group, and the respective groups in the aryloxy and the heteroaryloxy groups which may act as substituents of the alkanediyl, alkenediyl and alkynediyl group can be substituted by one or more, such as 1 to 8, substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl. Examples of the heteroaryl group are groups containing one or two heteroatoms selected from O and N as ring members, the remaining ring members being carbon atoms.

The 5 to 14 membered carbocyclic or heterocyclic group which is optionally substituted by one or more further substituents and which is formed by two substituents R^{S11}, together with the atoms to which they are attached, is preferably a 6 membered aromatic ring, such as a phenyl ring, or a 6 membered cycloalkyl ring, i.e. a cyclohexyl ring. As noted above, the 5 to 14 membered carbocyclic or heterocyclic group can be substituted by one or more, such as 1 to 8, substituents preferably independently selected from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.

More preferably, R⁶ is a divalent group of the formula —[CR⁷R⁸]ₘ—, wherein m represents an integer of 2 to 5, preferably 2 to 4, and more preferably 2 or 3.

R⁷ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl,
and/or two groups R⁷, e.g. groups R⁷ attached to adjacent carbon atoms, may be linked to form an optionally substituted 5- or 6-membered carbocyclic ring, such as an optionally substituted cyclohexyl group or an optionally substituted phenyl group, together with the carbon atoms to which they are attached. The 5- or 6-membered carbocyclic ring can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.

It is preferred that all of the groups R⁷ are hydrogen, or that two of the groups R⁷ are linked to form an optionally substituted 5- or 6-membered carbocyclic ring, such as an optionally substituted cyclohexyl group or an optionally substituted phenyl group, together with the carbon atoms to which they are attached, and that any remaining groups R⁷ are hydrogen.

R⁸ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl. Preferably, R⁸ is hydrogen.

It is still further preferred that (i) the variable m of the formula —[CR⁷R⁸]ₘ— is 2 or 3 and R⁷ and R⁸ are hydrogen, or (ii) that the variable m is 2, two groups R⁷ are linked to form an optionally substituted phenyl group or an optionally substituted cyclohexyl group together with the carbon atoms to which they are attached, and R⁸ is hydrogen. In line with the above, the optionally substituted phenyl group and the optionally substituted cyclohexyl group can be substituted by one or more substituents preferably selected independently from C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.

It is particularly preferred that R⁶ is selected from n-propane-1,3-diyl, ethane-1,2-diyl, benzene-1,2-diyl and cyclohexane-1,2-diyl. Most preferred as R⁶ is a group selected from n-propane-1,3-diyl, ethane-1,2-diyl, and cyclohexane-1,2-diyl.

In line with the above, and in a preferred embodiment, the ligands of formula (CL1A) are ligands of formula (CL2A), and the ligands of formula (CL1B) are ligands of formula (CL2B):

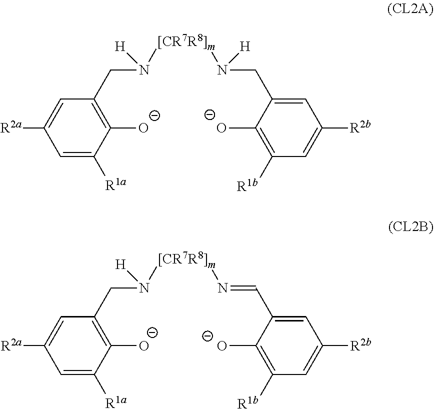

wherein R^{1a}, R^{1b}, R^{2a}, R^{2b}, R⁷ and R⁸ and the variable m are defined as described above, including any preferred embodiments thereof.

The ligands of formula (CL1A) and their preferred embodiments, including the ligands of formula (CL2A), are also referred to herein as salan-ligands, and the complexes carrying these ligands as salan-complexes or salan-catalysts. The ligands of formula (CL1B) and their preferred embodiments, including the ligands of formula (CL2B), are also referred to herein as salalen-ligands, and the complexes carrying these ligands as salalen-complexes or salalen-catalysts.

The chelate complex in accordance with the invention further comprises at least one, e.g. one or two, anionic nucleophilic ligands L^{N} which are coordinated as a further ligand/as further ligands to the rare earth metal cation. If more than one anionic nucleophilic ligand is present, the anionic nucleophilic ligands may be the same or may be different but are preferably the same.

Preferably, the number of anionic nucleophilic ligands is such that the sum of the negative charges of the chelate complex and the anionic nucleophilic ligand(s) balance the positive charge of the rare earth metal cation. Thus, in the preferred case where the rare earth metal cation is a three-valent cation, the chelate complex in accordance with the invention preferably comprises one anionic nucleophilic ligand.

As examples of anionic nucleophilic ligands, mention can be made of a halogen ligand, such as a chloro ligand, a hydrocarbyl ligand, an α-silylalkyl ligand, an amide ligand, a silylamide ligand (which may be a a bis-silylamide ligand), an alkoxide ligand, an aryloxide ligand, a borohydride (BH₄⁻) ligand, NO₃⁻, a carboxylate ligand, a thiolate ligand, a sulfate ligand, and a sulfonate ligand. Hydrocarbyl ligands as anionic nucleophilic ligands include, e.g., an alkyl ligand, an aryl ligand (which may be a cyclopentadienyl ligand), a benzyl ligand, an alkenyl ligand or an alkynyl ligand.

Preferred as an anionic nucleophilic ligand is a ligand selected from a bis(dialkylsilyl)amide ligand (e.g. a ligand with the formula —N(SiHR^{S4}R^{S5})₂, wherein R^{S4} and R^{S5} are independently selected from C1-C6 alkyl), a bis(trialkylsilyl)amide ligand (e.g. a ligand with the formula —N(SiR^{S4}R^{S5}R^{S6})₂, wherein R^{S4}, R^{S5} and R^{S6} are independently selected from C1-C6 alkyl), and an α-silylalkyl ligand (e.g. a ligand with the formula —CH₂—SiR^{S4}R^{S5}R^{S6}, wherein R^{S4}, R^{S5} and R^{S6} are independently selected from C1-C6 alkyl). More preferred is a ligand selected from the ligands with the formula —N(SiH(CH₃)₂)₂, N(Si(CH₃)₃)₂ and —CH₂Si(CH₃)₃. Particular preference is given to a ligand with the formula —N(SiH(CH₃)₂)₂.

Optionally, the chelate complex in accordance with the invention may comprise one or more neutral donor ligands L^{D} which are coordinated to the rare earth metal cation. For example, 1 or 2 of these neutral donor ligands may be present. Preferred examples of such neutral donor ligands are solvent molecules which are coordinated as solvent ligands L^{S} to the rare earth metal cation. As will be understood by the skilled person, such solvent ligands are typically provided by solvent molecules comprising a heteroatom with an electron lone-pair suitable for coordination to a metal center, such as tetrahydrofuran (THF), 1,4-dioxane, or diethylether.

The chelate complexes in accordance with the first aspect of the invention may consist of
a) a rare earth metal cation M, typically one rare earth metal cation;
b) a chelate ligand of formula (CL1A) or (CL1B), typically one chelate ligand of formula (CL1A) or (CL1B), or their preferred embodiments (CL2A) or (CL2B);
c) at least one anionic nucleophilic ligand L^{N}, which is coordinated as a further ligand to the rare earth metal cation; and
d) optionally one or more neutral solvent ligands L^{S} coordinated as ligands to the rare earth metal cation.

Thus, the chelate complex in accordance with the first aspect of the invention is preferably a complex of the following formula (K1A) or (K1B):

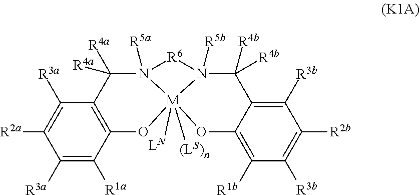

wherein
   M is a rare earth metal cation as defined above,
   L^{N} is an anionic nucleophilic ligand as defined above
   L^{S} is a neutral solvent ligand as defined above, and n is 0, 1 or 2,
   and wherein the definitions and preferred definitions for R^{1a}, R^{1b}, R^{2a}, R^{2b}, R^{3a}, R^{3b},
   R^{4a}, R^{4b}, R^{5a}, R^{5b} and R⁶ continue to apply which are provided in the context of aspect
   1 with regard to the chelate ligand of formula (CL1A),

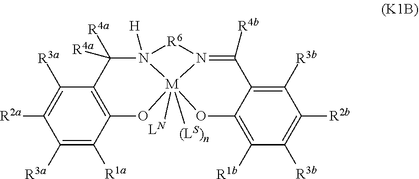

wherein
   M is a rare earth metal cation as defined above,
   L^{N} is an anionic nucleophilic ligand as defined above
   L^{S} is a neutral solvent ligand as defined above, and n is 0, 1 or 2,
   and wherein the definitions and preferred definitions for R^{1a}, R^{1b}, R^{2a}, R^{2b}, R^{3a}, R^{3b},
   R^{4a}, R^{4b} and R⁶ continue to apply which are provided in the context of aspect 1 with regard to the chelate ligand of formula (CL1B).

More preferably, the chelate metal complex is a complex of the formula (K2A) or (K2B)

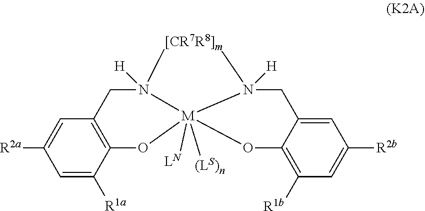

wherein
   M is a rare earth metal cation as defined above,
   L^{N} is an anionic nucleophilic ligand as defined above
   L^{S} is a neutral solvent ligand as defined above, and n is 0, 1 or 2,
   and wherein the definitions and preferred definitions for R^{1a}, R^{1b}, R^{2a}, R^{2b}, R⁷, R⁸ and
   m continue to apply which are provided in the context of aspect 1 with regard to the chelate ligand of formula (CL1A) and its preferred form (CL2A),

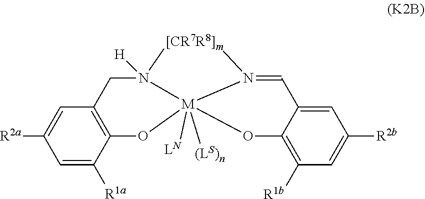

wherein
   M is a rare earth metal cation as defined above,
   L^{N} is an anionic nucleophilic ligand as defined above
   L^{S} is a neutral solvent ligand as defined above, and n is 0, 1 or 2,
   and wherein the definitions and preferred definitions for R^{1a}, R^{1b}, R^{2a}, R^{2b}, R⁷, R⁸ and
   m continue to apply which are provided in the context of aspect 1 with regard to the chelate ligand of formula (CL1B) and its preferred form (CL2B).

In order to provide an advantageous stereocontrol during the ring-opening polymerization of a chiral cyclic ester monomer, it is not necessary for the chelate complex in accordance with the invention to carry an optically active ligand, e.g. an optically active chelate ligand. Thus, a ligand of the chelate complex in accordance with the invention, such as a ligand of formula (CL1A) and (CL1B), does not need to comprise a chiral center, or, if a chiral center such as a chiral carbon atom is present in the ligand, it can be used in the form of a racemate to provide the chelate complex in accordance with the invention. As demonstrated herein, the chelate complex in accordance with the invention achieves a good stereocontrol without the need for an optically active ligand.

A further aspect (aspect 2) of the invention relates to a process for the preparation of a chelate complex, which is suitable for the preparation of the chelate complexes of the invention in accordance with aspect 1 above.

The process in accordance with the invention for the preparation of a chelate complex comprises a step of reacting a rare earth metal precursor comprising a rare earth metal cation M with one of b1 or b2
b1) a pro-ligand of formula (PL1A) or a deprotonated form thereof from which the protons of the phenolic hydroxy groups shown in formula (PL1A) are removed:

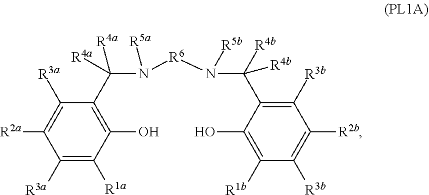

wherein the definitions and preferred definitions for R^{1a}, R^{1b}, R²³, R^{2b}, R^{3a}, R^{3b}, R^{4a}, R^{4b}, R^{5a}, R^{5b} and R⁶ continue to apply which are provided in the context of aspect 1 with regard to the chelate ligand of formula (CL1A),
b2) a pro-ligand of formula (PL1B) or a deprotonated form thereof from which the protons of the phenolic hydroxyl groups shown in formula (PL1B) are removed:

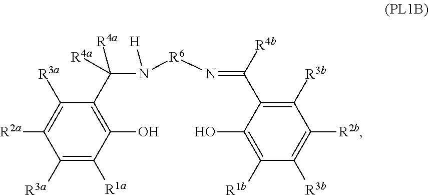

wherein the definitions and preferred definitions for R^{1a}, R^{1b}, R²³, R^{2b}, R^{3a}, R^{3b}, R^{4a}, R^{4b} and R⁶ continue to apply which are provided in the context of aspect 1 with regard to the chelate ligand of formula (CL1B), to form a chelate complex.

As will be understood by the skilled reader, the rare earth metal cation M comprised by the rare earth metal precursor provides the rare earth metal cation of the chelate complex prepared by the process. Thus, in line with the disclosure provided above for the rare earth metal cation in the context of the chelate complex in accordance with the invention, the rare earth metal is selected from scandium (Sc), yttrium (Y), and a lanthanoid metal, i.e. a metal with an atomic number in the periodic table of the elements of 57 to 71. Preferably, the rare earth metal is selected from Y, Yb, La and Lu. Still more preferably, it is selected from Y, Yb and Lu, and most preferably it is selected from Y and Lu. The rare earth metal cation is preferably a three-valent cation, which applies as well for the preferred species Y³⁺, Yb³⁺, La³⁺ and Lu³⁺ and their more preferred forms, so that most preferred as the rare earth metal cation are Y³⁺ and Lu³⁺.

Suitable rare earth metal precursors are known to the skilled person and are described in the literature.⁵⁶ Preferably, a rare earth metal complex is used as a rare earth metal precursor wherein the rare earth metal cation M is coordinated by an anionic nucleophilic ligand L^{N} as it will be present in the chelate complex that is prepared by the process and as it is defined above in the context of the chelate complex in accordance with the invention. Thus, particularly preferred as a rare earth metal precursor is a complex of the formula (PK1)

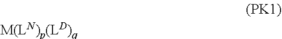

wherein
M is a rare earth metal cation,
p is an integer which corresponds to the valence of the cation M, and is preferably 3,
q is 1 to 4, preferably 2 to 4, and more preferably 2,
L^{N} is an anionic nucleophilic ligand, and
L^{D} is a neutral donor ligand, preferably a solvent ligand L^{S}.

Also in this context, the definitions and preferred definitions continue to apply which are provided in the context of aspect 1 with regard to the chelate complexes of formulae (K1A) and (K1B) for the rare earth metal cation M, the anionic nucleophilic ligand L^{N}, the neutral donor ligand L^{D} and the solvent Ligand L^{S}.

However, it is also possible to use a rare earth metal precursor wherein the rare earth metal cation is not coordinated by a ligand L^{N}. In this case, the process for the preparation of a rare earth metal complex in accordance with the invention typically comprises a step of reacting either the rare earth metal precursor with a nucleophilic anion L^{N-}, or of reacting the product obtained by the step of reacting the rare earth metal precursor with one of b1 or b2 with a nucleophilic anion L^{N-}. The nucleophilic anion L^{N-} of can be provided, e.g., from a suitable precursor compound by the removal of a proton with a suitable base, e.g. an alkali hydride such as KH. Thus, an exemplary counterion for the nucleophilic anion is an alkali cation, such as K⁺.

In accordance with a preferred process variant, a process is provided for the preparation of a chelate complex, which process comprises a step of reacting in a solvent
a) a precursor complex of the rare earth metal cation of the formula (PK1)

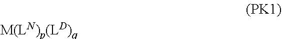

wherein
M is a rare earth metal cation,
p is an integer which corresponds to the valence of the cation M, and is preferably 3,
q is 1 to 4, preferably 2 to 4, and more preferably 2,
L^{N} is an anionic nucleophilic ligand, and
L^{D} is a neutral donor ligand, preferably a solvent ligand L^{S}, with one of b1 or b2
b1) a pro-ligand of formula (PL1A) or a deprotonated form thereof from which the protons of the phenolic hydroxyl groups shown in formula (PL1A) are removed:

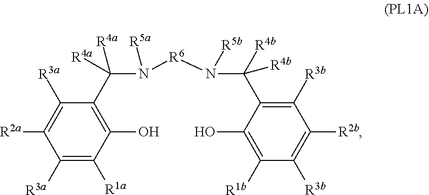

wherein the definitions and preferred definitions for R^{1a}, R^{1b}, R^{2a}, R^{2b}, R^{3a}, R^{3b}, R^{4a}, R^{4b}, R^{5a}, R^{5b} and R⁶ continue to apply which are provided in the context of aspect 1 with regard to the chelate ligand of formula (CL1A),
b2) a pro-ligand of formula (PL1B) or a deprotonated form thereof from which the protons of the phenolic hydroxyl groups shown in formula (PL1B) are removed:

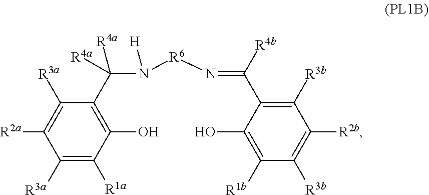

wherein the definitions and preferred definitions for R^{1a}, R^{1b}, R^{2a}, R^{2b}, R^{3a}, R^{3b}, R^{4a}, R^{4b} and R⁶ continue to apply which are provided in the context of aspect 1 with regard to the chelate ligand of formula (CL1B), to form a chelate complex.

As far as the rare earth metal cation M, the anionic nucleophilic ligand L^{N} and the neutral donor ligand L^{D} or the solvent Ligand L^{S} of the precursor complex of formula (PK1) are concerned, the definitions and preferred definitions continue to apply which are provided in the context of aspect 1 with regard to the chelate complexes of formulae (K1A) and (K1B).

In line with the discussion of preferred structures of the chelate ligands in the context of aspect 1 above, the pro-ligand of formula (PL1A) is more preferably a pro-ligand of formula (PL2A), and the pro-ligand of formula (PL1B) is more preferably a pro-ligand of formula (PL2B ):

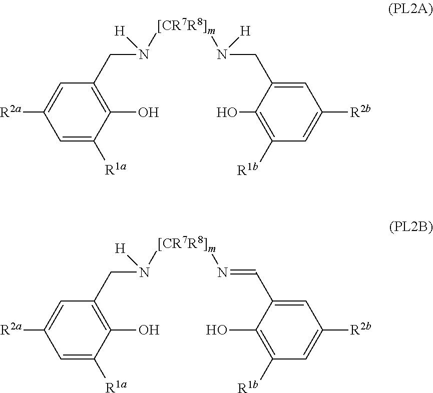

wherein the definitions and preferred definitions for R^{1a}, R^{1b}, R^{2a}, R^{2b}, R⁷, R⁸ and m continue to apply which are provided in the context of aspect 1 with regard to the chelate ligands of formulae (CL1A) and (CL1B) and their preferred forms (CL2A) and (CL2B), respectively. Thus, as will be understood by the skilled reader, any reference herein to the pro-ligands of formula (PL1A) and (PL1B) used in the context of the invention includes a reference to the pro-ligands of formulae (PL2A) and (PL2B) as more preferred forms thereof.

The pro-ligands of formula (PL1A) and (PL1B) used in the context of the invention can be prepared in analogy to processes described in the literature, such as i) Mannich-type reaction of phenols, formaldehyde (and its synthetic equivalents) and bis-amines,⁵⁰ ii) reduction of salen-type ligands (prepared by condensation of 2-hydroxy-benzaldehydes and bis-amines),⁵¹ or iii) substitution reaction of halomethylphenols with bis-amines.³⁵ The synthesis of rare earth metal precursor complexes is well known in the literature^{52, 53} Preference is given to the use of the pro-ligand of formula (PL1A) or the pro-ligand of formula (PL1B) over the use of the deprotonated forms thereof. If the deprotonated form is used, it can be provided via reaction of the pro-ligand with a suitable base, e.g. an alkali hydride such as KH. Thus, an exemplary counterion for the deprotonated form of the pro-ligand of formula (PL1A) or the deprotonated form of the pro-ligand of formula (PL1B) is an alkali cation, such as K⁺.

The rare earth metal precursor, such as the precursor complex of formula (PK1), is typically reacted with the pro-ligand of formula (PL1A) or with the deprotonated form thereof, or with the pro-ligand of formula (PL1B) or with the deprotonated form thereof, in a solvent, such as toluene, tetrahydrofuran (THF) or dichloromethane.

The reaction of the rare earth metal precursor, such as the precursor complex of formula (PK1), and component b1 or b2 is typically allowed to proceed by mixing them, e.g. by stirring a solution containing the rare earth metal precursor and the component b1 or the component b2.

The molar ratio of the rare earth metal precursor, such as the precursor complex of formula (PK1), and component b1 or b2, is preferably in the range of 2.0:1.0 to 1.0:2.0, more preferably in the range of 1.5:1.0 to 1.0:1.5 and is still more preferably 1.0:1.0.

The rare earth metal precursor, such as the precursor complex of formula (PK1), is typically contacted with the pro-ligand of formula (PL1A) or with the deprotonated form thereof, or with the pro-ligand of formula (PL1B) or with the deprotonated form thereof, at a temperature ranging from −78° C. to a temperature below the boiling point of the solvent used, e.g. 110° C. Preferably at a temperature around room temperature is used, such as 15 to 25° C.

The desired chelate complex is formed quickly, but extended reaction times do not have a negative effect, so that, for example, the reaction can be carried out for a period of time of 15 min to 24 hours.

The chelate complex which is formed by the process described above can be isolated, or can be formed in-situ in a reaction system which is subsequently used as a reaction system for the ring-opening polymerization (ROP) of cyclic esters as described in more detail below.

As will be understood by the skilled reader, a ligand exchange reaction desirably occurs when the rare earth metal precursor, such as the precursor complex of formula (PK1), is contacted with the pro-ligand of formula (PL1A) or with the deprotonated form thereof, or with the pro-ligand of formula (PL1B) or with the deprotonated form thereof, in line with the above. Thus, the complex provided by the process in accordance with the invention comprises a chelate ligand provided by the pro-ligand or the deprotonated form thereof. Typically, it also comprises at least one anionic nucleophilic ligand L^{N} which is coordinated as a further ligand to the rare earth metal cation; and optionally one or more neutral donor ligands coordinated as ligands to the rare earth metal cation.

If the chelate complex is to be isolated, a solvent can be removed by methods known in the art. The obtained chelate complex can optionally be recrystallized.

If desired, it is also possible to modify or exchange an anionic nucleophilic ligand comprised by the chelate complex by methods known in the art after the chelate complex has been prepared. Likewise, it is possible to modify or exchange a neutral donor ligand by methods known in the art after the chelate complex has been prepared. Thus, for example, one type of anionic nucleophilic ligand L^{N} can be replaced by another type of anionic nucleophilic ligand L^{N}. As examples of suitable reaction steps for the modification or replacement of a ligand L^{N} by another ligand L^{N} which may additionally be comprised by the process in accordance with the invention, reference may be made to the alcoholysis of amides by alcohols, salt metathesis of halides by metal alkyls or C—H metathesis reactions.^{55, 56} The invention further provides a chelate complex, in particular a chelate complex as defined in aspect 1 above, which is obtainable or is obtained by any of the process variants in accordance with aspect 2 discussed above.

It is noted that the chelate complexes in accordance with the invention can be prepared in analogy with methods described in the literature for chelate complexes with related ligand-types.⁵⁴⁻⁵⁶ Still a further aspect (aspect 3) of the invention relates to a process for the preparation of a polymer which comprises the polymerization of a chiral cyclic ester as a monomer and which relies on the catalytic activity of the chelate complexes in accordance with the invention.

The process for the preparation of a polymer in accordance with the invention comprises a step of contacting monomers comprising chiral cyclic ester monomers with a chelate complex in accordance with the first aspect of the invention, or a chelate complex obtainable by a process in accordance with the second aspect of the invention, to allow the polymerization reaction of the monomers to proceed.

Generally, the chiral cyclic ester monomers undergo a ring opening polymerization during the process for the preparation of a polymer in accordance with the invention. Thus, the polymer provided by the processes in accordance with the invention for the preparation of a polymer is generally a polymer comprising one or more types of repeating units of the formula —O—R^{P1}—C(O)— which are linked to adjacent units via an ester bond. Here, R^{P1} represents an alkanediyl group, e.g. a C3 to C8 alkanediyl group comprising a chiral carbon atom, and preferably a C3 alkanediyl group comprising a chiral carbon atom.

The monomers subjected to polymerization may consist of chiral cyclic ester monomers, or may comprise chiral cyclic ester monomers together with one or more other types of monomers. Generally, the chiral cyclic ester monomers provide the major part (i.e. more than 50 mol %, based on the total molar amount of all monomers) or all of the monomers to be polymerized.

The polymer provided by the process in accordance with the invention for the preparation of a polymer may be a homopolymer or a copolymer, preferably it is a homopolymer.

Preferably, the monomers which are subjected to polymerization using the process in accordance with the invention comprise or consist of chiral cyclic ester monomers of formula (M1), (M2) or (M3), or comprise or consist of a mixture thereof:

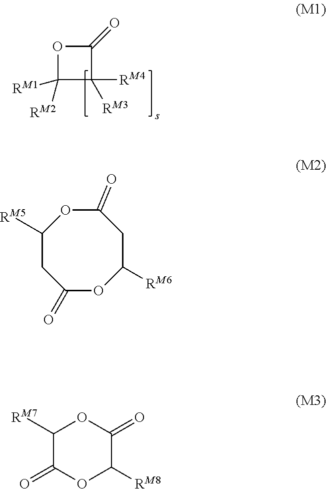

wherein:
R^{M1} to R^{M8} are independently selected from hydrogen and C1-C6 alkyl, with the proviso that R^{M1}, R^{M2} and, if present, R^{M3} and R^{M4} in formula (M1) are selected such that the monomer of formula (M1) contains at least one chiral carbon atom, that R^{M5} and R^{M6} in formula (M2) are selected such that the monomer of formula (M2) contains at least one chiral carbon atom and R^{M7} and R^{M8} in formula (M3) are selected such that the monomer of formula (M3) contains at least one chiral carbon atom. The variable s is 1, 2, 3 or 4. Preferably, R^{M5} to R^{M8} are methyl.

More preferably, the monomers comprise or consist of a chiral cyclic ester in the form of a racemic mixture of enantiomers, or in the form of a non-racemic mixture of enantiomers, e.g. the enantiomers of a compound of formula (M1), (M2) or (M3). Still more preferably, the monomers comprise or consist of a chiral cyclic ester in the form of a racemic mixture of enantiomers. The chelate complexes in accordance with the invention allow the polymerization reaction of chiral cyclic esters to proceed with a good control over the stereochemistry of the obtained polymer.

Optionally, the monomers comprising the preferred chiral cyclic ester in the form of a racemic mixture of enantiomers, or in the form of a non-racemic mixture of enantiomers, may further comprise non-chiral cyclic esters as co-monomers. However, as noted above, generally the chiral cyclic ester monomers provide the major part (i.e. more than 50 mol %, based on the total molar amount of all monomers) or all of the monomers to be polymerized.

Still more preferably, the monomers subjected to polymerization using the process in accordance with the invention comprise or consist of racemic β-butyrolactone (rac-BBL) or comprise or consist of a non-racemic mixture of its enantiomers, with preference being given to the racemic β-butyrolactone. Most preferably, the process in accordance with the invention for the preparation of a polymer is a process for the preparation of poly(3-hydroxybutyrate) via a ring opening polymerization reaction of rac-BBL.

There is no particular limitation with regard to the way in which the chelate complex in accordance with the invention and the monomers are contacted to allow the polymerization reaction to proceed.

The chelate complex in accordance with the invention and the monomers may be contacted in a solvent, such as toluene, THF or dichloromethane in order to accomplish the polymerization. For example, the chelate complex and of the monomers may be added in any order to a solvent, such as the addition of the chelate complex to a solution of the monomers, or the addition of the monomers to a solution of the chelate complex. The solution of the chelate complex may be a solution in which the chelate complex has been prepared, e.g. via a process for the preparation of a chelate complex as discussed above, and to which the monomers are added without the isolation of the chelate complex from the solution. A chelate complex formed in solution and used without its prior isolation for the preparation of a polymer is also referred to as an in situ formed chelate complex or an in situ formed chelate catalyst herein. This latter approach can be advantageous in that it can be carried out very quickly and efficiently.

Alternatively, the polymerization process in accordance with the invention may be carried out as a bulk polymerization wherein the monomers to be polymerized are not dissolved in a solvent, e.g. if monomers are polymerized which are liquid.

It is preferred that the process for the preparation of a polymer in accordance with the invention comprises
a step of reacting, in a suitable solvent,
a) a precursor complex of the rare earth metal cation of formula (PK1)

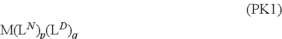

wherein
M is a rare earth metal cation,
p is an integer which corresponds to the valence of the cation M, and is preferably 3,
q is 1 to 4, preferably 2 to 4, and more preferably 2,
L^{N} is an anionic nucleophilic ligand, and
L^{D} is a neutral donor ligand, preferably a solvent ligand L^{S}, with one of b1 or b2
b1) a pro-ligand of formula (PL1A) or a deprotonated form thereof from which the protons of the phenolic hydroxyl groups shown in formula (PL1A) are removed:

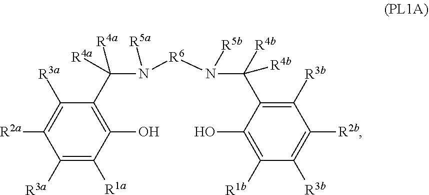

wherein the definitions and preferred definitions for R^{1a}, R^{1b}, R^{2a}, R^{2b}, R^{3a}, R^{3b}, R^{4a}, R^{4b}, R^{5a}, R^{5b} and R⁶ continue to apply which are provided in the context of aspect 1 with regard to the chelate ligand of formula (CL1A),
   b2) a pro-ligand of formula (PL1B) or a deprotonated form thereof from which the protons of the phenolic hydroxyl groups shown in formula (PL1B) are removed:

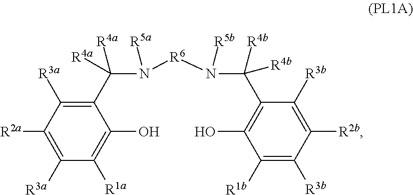

wherein the definitions and preferred definitions for R^{1a}, R^{1b}, R^{2a}, R^{2b}, R^{3a}, R^{3b}, R^{4a}, R^{4b} and R⁶ continue to apply which are provided in the context of aspect 1 with regard to the chelate ligand of formula (CL1B), to form a chelate complex,
and a step of contacting monomers comprising cyclic ester monomers with the formed chelate complex without prior isolation of the complex to allow a polymerization reaction of the monomers to proceed.

If the process for the preparation of a polymer in accordance with the invention comprises adding the monomers to a solution of the chelate complex in which the chelate complex has been prepared, and to which the monomers are added without the prior isolation of the chelate complex from the solution, the monomers can be added to the solution of the chelate complex shortly after the components required for the formation of the chelate complex have been brought into contact, e.g. after 10 min or more, preferably after 15 min or more.

In the process for the preparation of a polymer in accordance with the invention, the chelate complex and the monomers are typically contacted at a temperature in the range of −78° C. to 100° C., preferably −50° C. to 60° C. At lower temperatures, e.g. temperatures below 0° C., a higher degree of stereocontrol can be achieved if the monomers comprise a chiral cyclic ester, such as β-butyrolactone. However, a temperature around room temperature, e.g. in the range of 15 to 25° C., may be preferable in order to carry out the process conveniently without the need for additional cooling.

In the process in accordance with the invention for the preparation of a polymer, the molar ratio of the monomers to the chelate complex, calculated on the basis of the molar amount of rare earth metal cations, is preferably in the range of 100 to 10000, preferably 200 to 5000.

The chelate complexes in accordance with the invention provide highly active polymerization catalysts, in particular for the ring opening polymerization of cyclic ester monomers. Very high turnover frequencies (TOF) are achieved. Thus polymers can be obtained in short reaction times, and the polymerization reaction is typically carried out over a period of 0.5 min to 5 hours, preferably 1 min to 3 hours.

In line with the above process, chelate complexes in accordance with the invention can be used to convert chiral cyclic ester monomers into a polymer with a high degree of isotacticity. For example, if a racemic mixture of an (R)-enantiomer and an (S)-enantiomer of a chiral monomer is subjected to polymerization in the presence of a chelate complex in accordance with the invention, a mixture of a first type and a second type of polymer molecules can be obtained, the first type being predominantly formed from the (R)-enantiomer and the second type being predominantly formed from the (S)-enantiomer.

If desired, additives such as alcohols, amines or derivatives thereof can be added to the chelate complex or to the polymerization mixture to exert additional control over the stereochemistry of the obtained polymer if the monomers comprise a chiral cyclic ester, such as β-butyrolactone.

In an aspect related to the above process, the present invention provides the use of a chelate complex in accordance with the invention, i.e. a chelate complex in accordance with the first aspect of the invention, or a chelate complex obtainable by a process in accordance with the second aspect of the invention, as a catalyst for a polymerization reaction, in particular a ring-opening polymerization reaction, of monomers comprising a cyclic ester monomer. As will be understood by the skilled reader, the information provided in the context of the discussion of the process for the preparation of the polymer with respect to the monomers comprising a cyclic ester monomer continue to apply for the use in accordance with the invention.

As explained above, the chelate complexes in accordance with the invention and the process for the preparation of a polymer in accordance with the invention make polymers accessible which could not be previously obtained. In particular, the invention allows the preparation of poly(3-hydroxybutyrate) with high isoselectivity and a high molecular weight. Thus, in a further aspect, the invention provides poly(3-hydroxybutyrate) characterized by an isotacticity Pₘ in the range of 0.78 to 0.92, preferably 0.78 to 0.89, more preferably 0.82 to 0.89. The number average molecular weight Mₙ of the polymer is preferably 12 kg mol⁻¹ or more, e.g. 12 to 580 kg mol⁻¹, more preferably 25 kg mol⁻¹ or more, and still more preferably 40 kg mol⁻¹ or more. The polydispersity index PDI is preferably 1.5-3.5. In line with the above, the poly(3-hydroxybutyrate) in accordance with the invention can be provided as a mixture of polymer chains comprising predominantly (R)-hydroxybutanoate units and having an isotacticity in the range of 0.78 to 0.92, preferably 0.78 to 0.89, more preferably 0.82 to 0.89, and of polymer chains comprising predominantly (S)-hydroxybutanoate units and having an isotacticity in the range of 0.78 to 0.92, preferably 0.78 to 0.89, more preferably 0.82 to 0.89. The preferred number average molecular weight and the range for preferred polydispersities continue to apply also in this context.

In line with the skilled person's understanding, the isotacticity index Pₘ is the probability of meso linkages in the polymer chain, and is determined by ¹³C NMR. The weight average molecular weight of the polymer M_{w}, the number average molecular weight of the polymer Mₙ and the polydispersity index M_{w}/Mₙ are determined via gel permeation chromatography using chloroform as eluent at a flow rate of 1.0 ml min⁻¹ and polystyrene as a standard.

In the following items, general and preferred aspects of the invention are further summarized.
1. A chelate complex comprising:
a) a rare earth metal cation M;
b) a chelate ligand of formula (CL1A) or (CL1B)

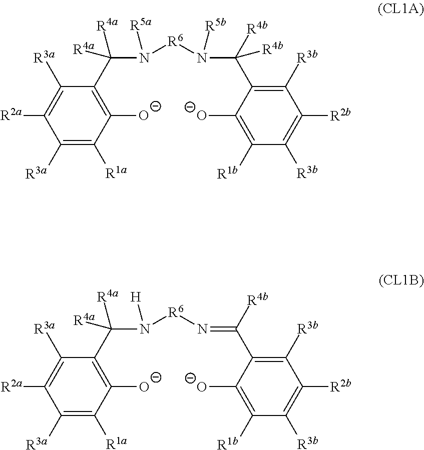

wherein
the chelate ligand is coordinated via the two nitrogen atoms and the two oxygen atoms shown in the formulae to the rare earth metal cation,
   R^{1a} and R^{1b} independently represent a sterically demanding group comprising 6 or more skeleton atoms, preferably 6 or more skeleton atoms selected from carbon, silicon, oxygen and nitrogen, and more preferably 6 or more carbon atoms optionally in combination with other types of skeleton atoms, and optionally, R^{1a} and R^{1b} may be linked to each other to provide a divalent organic residue,
   R^{2a} and R^{2b} are independently selected from hydrogen, C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} (where R^{S9} and R^{S10} are independently selected from C1-C5 alkyl), a group of the formula (S-1)

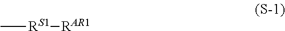

wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted, and a group of the formula (S-2)

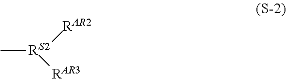

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted,
   R^{3a} and R^{3b} are, independently for each occurrence, selected from hydrogen, C1-C10 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} (where R^{S9} and R^{S10} are independently selected from C1-C5 alkyl),
   R^{4a} and R^{4b} are selected, independently for each occurrence, from hydrogen, C1-C3 alkyl, halogen (such as F, Cl or Br), —NO₂, —CN, C1-C3 haloalkyl (such as fluoroalkyl) and C1-C3 alkoxy,
   R^{5a} and R^{5b} are independently selected from hydrogen, alkyl, cycloalkyl and phenyl, with the proviso that one of R^{5a} and R^{5b} must be hydrogen, R⁶ is selected from a C2-C5 alkanediyl, a C2-C5 alkenediyl and a C2-C5 alkynediyl group, preferably from a C2-C3 alkanediyl, a C2-C3 alkenediyl and a C2-C3 alkynediyl group and is more preferably C2-C3 alkanediyl,
wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} (where R^{S9} and R^{S10} are independently selected from C1-C5 alkyl), and/or
two substituents R^{S11}, e.g substituents R^{S11} attached to adjacent carbon atoms of the alkanediyl, alkenediyl or alkynediyl group, may be linked to form, together with the atoms to which they are attached, a 5 to 14 membered carbocyclic or heterocyclic group which is optionally substituted by one or more further substituents;
c) at least one anionic nucleophilic ligand L^{N} which is coordinated as a further ligand to the rare earth metal cation; and
d) optionally one or more neutral donor ligands L^{D} coordinated as ligands to the rare earth metal cation.
2. The chelate complex in accordance with item 1, wherein the rare earth metal providing the rare earth metal cation M is selected from Y, Yb, La and Lu, more preferably from Y, Yb and Lu, and most preferably from Y and Lu.
3. The chelate complex in accordance with item 1 or 2, wherein the rare earth metal cation is a three-valent cation.
4. The chelate complex in accordance with any of items 1 to 3, wherein R^{1a} and R^{1b} are independently selected from the following (i) to (iii):
(i) a branched C6 to C15 alkyl group comprising at least one of a tertiary and a quaternary carbon atom or a branched C6 to C15 alkoxy group comprising at least one of a tertiary and a quaternary carbon atom, which branched alkyl group and branched alkoxy group is optionally substituted;
(ii) a group of the formula (S-1):

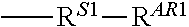

wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted; and
(iii) a group of the formula (S-2)

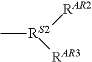

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted.
5. The chelate complex in accordance with item 4 wherein R^{1a} and R^{1b} are independently selected from:
(i) a group of the formula (S-3):

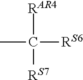

wherein R^{S6} and R^{S7} are independently selected from H and C1-C3 alkyl, preferably from H and methyl, and are preferably both methyl, and R^{AR4} is a phenyl group which is optionally substituted; and
(ii) a group of the formula (S-4):

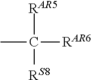

wherein R^{S8} is selected from H and C1-C3 alkyl, preferably from H and methyl, and is preferably methyl; and R^{AR5} and R^{AR6} are independently a phenyl group which is optionally substituted.
6. The chelate complex in accordance with any of items 1 to 5, wherein R^{2a} and R^{2b} are independently selected from H, a C1-C20 alkyl group, a group of the formula (S-3) as defined in item 5 and a group of the formula (S-4) as defined in item 5.
7. The chelate complex in accordance with item 6, wherein R²¹ and R^{2b} are independently selected from a branched C4 to C6 alkyl group comprising at least one of a tertiary and a quaternary carbon atom, a group of the formula (S-3) as defined in item 5 and a group of the formula (S-4) as defined in item 5.
8. The chelate complex in accordance with any of items 1 to 7, wherein R^{3a} and R^{3b} are hydrogen.
9. The chelate complex in accordance with any of items 1 to 8, wherein R^{4a} and R^{4b} are hydrogen.
10. The chelate complex in accordance with any of items 1 to 9, wherein R^{5a} and R^{5b} are hydrogen.
11. The chelate complex in accordance with any of items 1 to 10, wherein R⁶ is a divalent group of the formula —[CR⁷R⁸]ₘ—,
wherein m represents an integer of 2 to 5, preferably 2 to 4, and more preferably 2 or 3; R⁷ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl,
and/or two groups R⁷, e.g. groups R⁷ attached to adjacent carbon atoms, may be linked to form an optionally substituted 5- or 6-membered carbocyclic ring, such as an optionally substituted cyclohexyl group or an optionally substituted phenyl group, together with the carbon atoms to which they are attached; and
R⁸ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.
12. The chelate complex in accordance with item 11, wherein all of the groups R⁷ are hydrogen, or two of the groups R⁷ are linked to form an optionally substituted 5- or 6-membered carbocyclic ring, such as an optionally substituted cyclohexyl group or an optionally substituted phenyl group, together with the carbon atoms to which they are attached, and any remaining groups R⁷ are hydrogen.
13. The chelate complex in accordance with item 11 or 12, wherein R⁸ is hydrogen.
14. The chelate complex in accordance with any of items 11 to 13, wherein (i) the variable m of the formula —[CR⁷R⁸]ₘ— is 2 or 3 and R⁷ and R⁸ are hydrogen, or (ii) the variable m is 2, two groups R⁷ are linked to form an optionally substituted phenyl group or an optionally substituted cyclohexyl group together with the carbon atoms to which they are attached, and R⁸ is hydrogen.
15. The chelate complex in accordance with any of items 1 to 14, wherein the anionic nucleophilic ligand(s) is (are) selected from a halogen ligand such as a chloro ligand, a hydrocarbyl ligand, an α-silylalkyl ligand, an amide ligand, a silylamide ligand (which may be a bis-silylamide ligand), an alkoxide ligand, an aryloxide ligand, a borohydride (BH₄⁻) ligand, NO₃⁻, a carboxylate ligand, a thiolate ligand, a sulfate ligand, and a sulfonate ligand.
16. The chelate complex in accordance with item 15, wherein the anionic nucleophilic ligand(s) is (are) selected from a bis(dialkylsilyl)amide ligand (e.g. a ligand with the formula —N(SiHR^{S4}R^{S5})₂, wherein R^{S4} and R^{S5} are independently selected from C1-C6 alkyl), a bis(trialkylsilyl)amide ligand (e.g. a ligand with the formula —N(SiR^{S4}R^{S5}R^{S6})₂, wherein R^{S4}, R^{S5} and R^{S6} are independently selected from C1-C6 alkyl), and an α-silylalkyl ligand (e.g. a ligand with the formula —CH₂—SiR^{S4}R^{S5}R^{S6}, wherein R^{S4}, R^{S5} and R^{S6} are independently selected from C1-C6 alkyl).
17. The chelate complex in accordance with item 16, wherein the anionic nucleophilic ligand(s) is (are) selected from the ligands with the formula —N(SiH(CH₃)₂)₂, —N(Si(CH₃)₃)₂ and —CH₂Si(CH₃)₃.
18. The chelate complex in accordance with any of items 1 to 17, wherein the optional neutral donor ligand(s) is (are) a solvent ligand L^{S}.
19. The chelate complex in accordance with item 18, wherein the solvent ligand L^{S} is provided by a solvent molecule comprising a heteroatom with an electron lone-pair, more preferably by tetrahydrofuran (THF), 1,4-dioxane, or diethylether.
20. The chelate complex in accordance with any of items 1 to 19, which is a complex of the following formula (K1A) or (K1B):

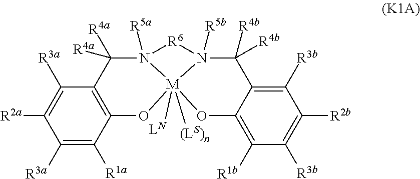

wherein n is 0, 1, or 2,
and the variables M, L^{N}, L^{S}, R^{1a}, R^{1b}, R^{2a}, R^{2b}, R^{3a}, R^{3b}, R^{4a}, R^{4b}, R^{5a}, R^{5b} and R⁶ are defined as in the preceding items,

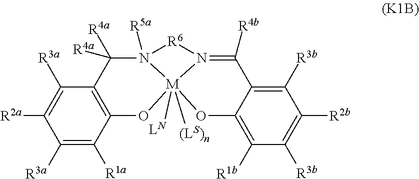

wherein n is 0, 1, or 2,
and the variables M, L^{N}, L^{S}, R^{1a}, R^{1b}, R^{2a}, R^{2b}, R^{3a}, R^{3b}, R^{4a}, R^{4b} and R⁶ are defined as in the preceding items.
21. A process for the preparation of a chelate complex, said process comprising a step of reacting a rare earth metal precursor which comprises a rare earth metal cation M with one of b1 or b2
   b1) a pro-ligand of formula (PL1A) or a deprotonated form thereof from which the protons of the phenolic hydroxy groups shown in formula (PL1A) are removed:

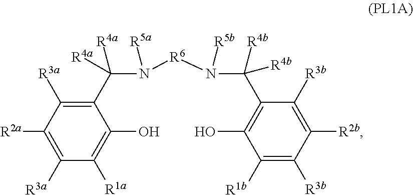

b2) a pro-ligand of formula (PL1B) or a deprotonated form thereof from which the protons of the phenolic hydroxyl groups shown in formula (PL1B) are removed:

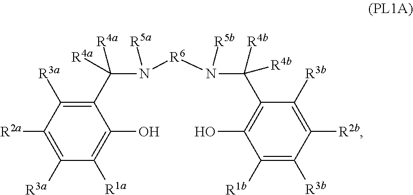

to form a chelate complex,
wherein
   R^{1a} and R^{1b} independently represent a sterically demanding group comprising 6 or more skeleton atoms, preferably 6 or more skeleton atoms selected from carbon, silicon, oxygen and nitrogen, and more preferably 6 or more carbon atoms optionally in combination with other types of skeleton atoms, and optionally, R^{1a} and R^{1b} may be linked to each other to provide a divalent organic residue,
   R^{2a} and R^{2b} are independently selected from hydrogen, C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} (where R^{S9} and R^{S10} are independently selected from C1-C5 alkyl), a group of the formula (S-1)

R^{S1}—R^{AR1} (S-1)
wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted, and a group of the formula (S-2)

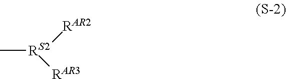

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted,
   R^{3a} and R^{3b} are, independently for each occurrence, selected from hydrogen, C1-C10 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} (where R^{S9} and R^{S10} are independently selected from C1-C5 alkyl),
   R^{4a} and R^{4b} are selected, independently for each occurrence, from hydrogen, C1-C3 alkyl, halogen (such as F, Cl or Br), —NO₂, —CN, C1-C3 haloalkyl (such as fluoroalkyl) and C1-C3 alkoxy,
   R^{5a} and R^{5b} are independently selected from hydrogen, alkyl, cycloalkyl and phenyl, with the proviso that one of R^{5a} and R^{5b} must be hydrogen,
   R⁶ is selected from a C2-C5 alkanediyl, a C2-C5 alkenediyl and a C2-C5 alkynediyl group, preferably from a C2-C3 alkanediyl, a C2-C3 alkenediyl and a C2-C3 alkynediyl group and is more preferably C2-C3 alkanediyl,
wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen (such as F, Cl and Br), —NO₂, —CN, C1-C10 haloalkyl (such as fluoroalkyl), C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} (where R^{S9} and R^{S10} are independently selected from C1-C5 alkyl), and/or two substituents R^{S11}, e.g substituents R^{S11} attached to adjacent carbon atoms of the alkanediyl, alkenediyl or alkynediyl group, may be linked to form, together with the atoms to which they are attached, a 5 to 14 membered carbocyclic or heterocyclic group which is optionally substituted by one or more further substituents.
22. The process in accordance with item 21, wherein R^{1a} and R^{1b} are independently selected from the following (i) to (iii):
(i) a branched C6 to C15 alkyl group comprising at least one of a tertiary and a quaternary carbon atom or a branched C6 to C15 alkoxy group comprising at least one of a tertiary and a quaternary carbon atom, which branched alkyl group and branched alkoxy group is optionally substituted;
(ii) a group of the formula (S-1):

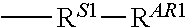

wherein R^{S1} is selected from a C1-C9 divalent alkyl group (alkanediyl group) which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted; and
(iii) a group of the formula (S-2)

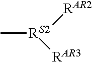

wherein R^{S2} is selected from a C1-C6 trivalent alkyl group (alkanetriyl group) which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted.
23. The process in accordance with item 22 wherein R^{1a} and R^{1b} are independently selected from:
(i) a group of the formula (S-3):

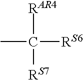

wherein R^{S6} and R^{S7} are independently selected from H and C1-C3 alkyl, preferably from H and methyl, and are preferably both methyl, and R^{AR4} is a phenyl group which is optionally substituted; and
(ii) a group of the formula (S-4):

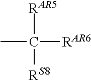

wherein R^{S8} is selected from H and C1-C3 alkyl, preferably from H and methyl, and is preferably methyl; and R^{AR5} and R^{AR6} are independently a phenyl group which is optionally substituted.
24. The process in accordance with any of items 21 to 23, wherein R²¹ and R^{2b} are independently selected from H, a C1-C20 alkyl group, a group of the formula (S-3) as defined in item 5 or item 23 and a group of the formula (S-4) as defined in item 5 or item 23.
25. The process in accordance with item 24, wherein R^{2a} and R^{2b} are independently selected from a branched C4 to C6 alkyl group comprising at least one of a tertiary and a quaternary carbon atom, a group of the formula (S-3) as defined in item 5 or item 23 and a group of the formula (S-4) as defined in item 5 or item 23.
26. The process in accordance with any of items 21 to 25, wherein R^{3a} and R^{3b} are hydrogen.
27. The process in accordance with any of items 21 to 26, wherein R^{4a} and R^{4b} are hydrogen.
28. The process in accordance with any of items 21 to 27, wherein R^{5a} and R^{5b} are hydrogen.
29. The process in accordance with any of items 21 to 28, wherein R⁶ is a divalent group of the formula —[CR⁷R⁸]ₘ—,
wherein m represents an integer of 2 to 5, preferably 2 to 4, and more preferably 2 or 3;
R⁷ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl,
and/or two groups R⁷, e.g. groups R⁷ attached to adjacent carbon atoms, may be linked to form an optionally substituted 5- or 6-membered carbocyclic ring, such as an optionally substituted cyclohexyl group or an optionally substituted phenyl group, together with the carbon atoms to which they are attached; and
R⁸ is selected, independently for each occurrence, from hydrogen, C1-C10 alkyl, C2-C5 alkenyl, C2-C5 alkynyl, halogen (such as F, Cl or Br), —NO₂, —CN, C1-C10 haloalkyl (such as fluoroalkyl), C1-C10 alkoxy, and —NR^{S9}R^{S10} where R^{S9} and R^{S10} are independently selected from C1-C5 alkyl.
30. The process in accordance with item 29, wherein all of the groups R⁷ are hydrogen, or two of the groups R⁷ are linked to form an optionally substituted 5- or 6-membered carbocyclic ring, such as an optionally substituted cyclohexyl group or an optionally substituted phenyl group, together with the carbon atoms to which they are attached, and any remaining groups R⁷ are hydrogen.
31. The process in accordance with item 29 or 30, wherein R⁸ is hydrogen.
32. The process in accordance with any of items 29 to 31, wherein (i) the variable m of the formula —[CR⁷R⁸]ₘ— is 2 or 3 and R⁷ and R⁸ are hydrogen, or (ii) the variable m is 2, two groups R⁷ are linked to form an optionally substituted phenyl group or an optionally substituted cyclohexyl group together with the carbon atoms to which they are attached, and R⁸ is hydrogen.
33. The process in accordance with any of items 21 to 32, wherein the rare earth metal precursor comprising a rare earth metal cation M is a precursor complex of formula (PK1):

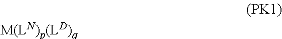

wherein
M is a rare earth metal cation,
p is an integer which corresponds to the valence of the cation M,
q is 1 to 4,
L^{N} is an anionic nucleophilic ligand, and
L^{D} is a neutral donor ligand, preferably a solvent ligand L^{S}.
34. The process in accordance with any of items 21 to 33, wherein the rare earth metal providing the rare earth metal cation M is selected from Y, Yb, La and Lu, more preferably from Y, Yb and Lu, and most preferably from Y and Lu.
35. The process in accordance with any of items 21 to 34, wherein the rare earth metal cation is a three-valent cation.
36. The process in accordance with any of items 33 to 35, wherein the anionic nucleophilic ligand is selected from a halogen ligand, such as a chloro ligand, a hydrocarbyl ligand, an α-silylalkyl ligand, an amide ligand, a silylamide ligand (which may be a bis-silylamide ligand), an alkoxide ligand, an aryloxide ligand, a borohydride (BH₄⁻) ligand, NO₃⁻, a carboxylate ligand, a thiolate ligand, a sulfate ligand, and a sulfonate ligand.
37. The process in accordance with item 36, wherein the anionic nucleophilic ligand(s) is (are) selected from a bis(dialkylsilyl)amide ligand (e.g. a ligand with the formula —N(SiHR^{S4}R^{S5})₂, wherein R^{S4} and R^{S5} are independently selected from C1-C6 alkyl), a bis(trialkylsilyl)amide ligand (e.g. a ligand with the formula —N(SiR^{S4}R^{S5}R^{S6})₂, wherein R^{S4}, R^{S5} and R^{S6} are independently selected from C1-C6 alkyl), and an α-silylalkyl ligand (e.g. a ligand with the formula —CH₂—SiR^{S4}R^{S5}R^{S6}, wherein R^{S4}, R^{S5} and R^{S6} are independently selected from C1-C6 alkyl).
38. The process in accordance with item 37, wherein the anionic nucleophilic ligand is selected from the ligands with the formula —N(SiH(CH₃)₂)₂, —N(Si(CH₃)₃)₂ and —CH₂Si(CH₃)₃.
39. The process in accordance with any of items 33 to 38, wherein the optional neutral donor ligand is a solvent ligand L^{S}.
40. The process in accordance with item 39, wherein the solvent ligand L^{S} is provided by a solvent molecule comprising a heteroatom with an electron lone-pair, more preferably by tetrahydrofuran (THF), 1,4-dioxane, or diethylether.
41. A process for the preparation of a polymer, comprising a step of contacting monomers comprising chiral cyclic ester monomers with a chelate complex in accordance any of items 1 to 20 or with a chelate complex obtainable by the process in accordance with any of items 21 to 40, to allow a polymerization reaction of the monomers to proceed.
42. The process for the preparation of a polymer in accordance with item 41, which comprises
a step of reacting, in a suitable solvent,
a) a precursor complex of formula (PK1)

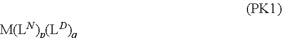

wherein
M is a rare earth metal cation,
p is an integer which corresponds to the valence of the cation M,
q is 1 to 4,
L^{N} is an anionic nucleophilic ligand, and
L^{D} is a neutral donor ligand, preferably a solvent ligand L^{S}, with one of b1 or b2
b1) a pro-ligand of formula (PL1A) or a deprotonated form thereof from which the protons of the phenolic hydroxyl groups shown in formula (PL1A) are removed:

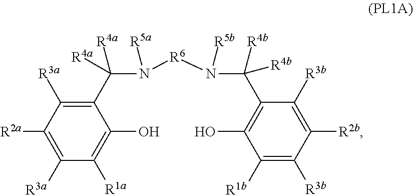

b2) a pro-ligand of formula (PL1B) or a deprotonated form thereof from which the protons of the phenolic hydroxyl groups shown in formula (PL1B) are removed:

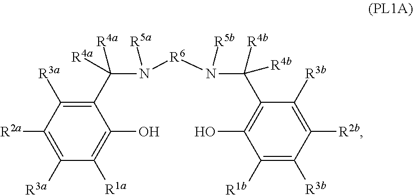

wherein in formulae (PL1A) and (PL1B) R^{1a}, R^{1b}, R^{2a}, R^{2b}, R^{3a}, R^{3b}, R^{4a}, R^{4b}, R^{5a}, R^{5b} and R⁶ are defined as in any of items 21 to 32,
to form a chelate complex,
and a step of contacting monomers comprising chiral cyclic ester monomers with the formed chelate complex without prior isolation of the chelate complex,
to allow a polymerization reaction of the monomers to proceed.
43. The process for the preparation of a polymer in accordance with item 42, wherein the precursor complex of the rare earth metal cation of formula (PK1) is defined in accordance with any of items 34 to 40.
44. Use of a chelate complex in accordance with any one of any of items 1 to 20 or with a chelate complex obtainable by the process in accordance with any of items 21 to 40 as a catalyst for a polymerization reaction of monomers comprising a chiral cyclic ester monomer.
45. The process for the preparation of a polymer in accordance with any of items 41 to 43 or the use in accordance with item 44, wherein the monomers comprise chiral cyclic ester monomers of formula (M1), (M2) or (M3), or a mixture thereof:

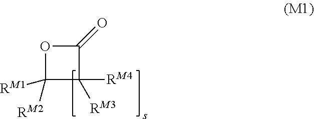

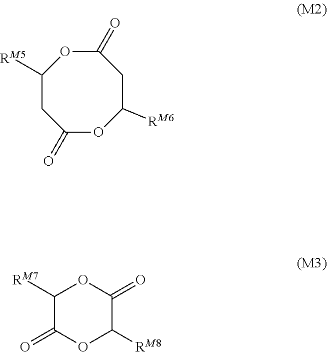

wherein:
R^{M1} to R^{M8} are independently selected from hydrogen and C1-C6 alkyl, with the proviso that R^{M1}, R^{M2} and, if present, R^{M3} and R^{M4} in formula (M1) are selected such that the monomer of formula (M1) contains at least one chiral carbon atom, that R^{M5} and R^{M6} in formula (M2) are selected such that the monomer of formula (M2) contains at least one chiral carbon atom and R^{M7} and R^{M}a in formula (M3) are selected such that the monomer of formula (M3) contains at least one chiral carbon atom,
and the variables is 1, 2, 3 or 4.
46. The process for the preparation of a polymer in accordance with any of items 41 to 43 or the use in accordance with item 44, wherein the monomers comprise racemic β-butyrolactone.
47. The process for the preparation of a polymer in accordance with any of items 41 to 43, wherein the polymer is poly(3-hydroxybutyrate).
48. A polymer obtainable by or obtained by the process or use in accordance with any of items 41 to 47.
49. Poly(3-hydroxybutyrate), characterized by an isotacticity Pₘ in the range of 0.78 to 0.92, preferably 0.78 to 0.89, more preferably in the range of 0.82 to 0.89.
50. The poly(3-hydroxybutyrate) in accordance with item 49, which has a number average molecular weight Mₙ of 12 kg mol⁻¹ or more, preferably 25 kg mol⁻¹ or more and more preferably 40 kg mol⁻¹ or more.
51. The poly(3-hydroxybutyrate) in accordance with item 49 or 50, which has a polydispersity index PDI of 1.5-3.5.
52. The poly(3-hydroxybutyrate) in accordance with any of items 49 to 51, which is provided as a mixture of polymer chains comprising predominantly (R)-hydoxybutanoate units and having an isotacticity in the range of 0.78 to 0.92, preferably 0.78 to 0.89, more preferably 0.82 to 0.89, and of polymer chains comprising predominantly (S)-hydoxybutanoate units and having an isotacticity in the range of 0.78 to 0.92, preferably 0.78 to 0.89, more preferably 0.82 to 0.89.

### EXAMPLES

### Materials and Methods

All manipulations containing air- and/or moisture sensitive compounds were carried out under argon atmosphere using standard Schlenk or glovebox techniques. Glassware was flame-dried under vacuum prior to use. Unless otherwise stated, all chemicals were purchased from Sigma-Aldrich, TCI Chemicals or ABCR and used as received. Solvents were obtained from an MBraun MB-SPS 800 solvent purification system and stored over 3 Å molecular sieves prior to use. Rac-BBL was dried over CaH₂ and distilled prior to use. Y[N(SiHMe₂)₂]₃(THF)₂,⁵⁷ La[N(SiHMe₂)₂]₃(THF)₂,⁵⁷ and Schiff base precursors L1′ and L2′ were prepared according to literature procedures.⁴³ Schiff base precursors L3′ and L4′ were prepared according to literature procedures but 3-trityl-5-tert-butylsalicylaldehyde was used instead of 3-trityl-5-methylsalicylaldehyde, and 3,5-dicumylsalicylaldehyde was used instead of 3,5-bis(tert-butyl)salicylaldehyde, respectively.⁴³

Nuclear magnetic resonance (NMR) spectra were recorded on a Bruker AV-III-500 spectrometer equipped with a QNP-Cryoprobe or AV-III-400 spectrometers at ambient temperature (298 K). ¹H and ¹³C{¹H}NMR spectroscopic chemical shifts δ are reported in ppm relative to tetramethylsilane and were referenced internally to the relevant residual solvent resonances. The following abbreviations are used: br, broad; s, singlet; d, doublet; t, triplet; p, pentet; m, multiplet; AB, AB system. The tacticity of PHB was determined by integration of the carbonyl region of the ¹³C{¹H}NMR spectrum.²⁶

Elemental analyses were measured with a EURO EA instrument from HEKAtech at the Laboratory for Microanalysis, Catalysis Research Center, Technical University of Munich. Liquid Injection Field Desorption Ionization Mass Spectrometry (LIFDI-MS) was measured directly from an inert atmosphere glovebox with a Thermo Fisher Scientific Exactive Plus Orbitrap equipped with an ion source from Linden CMS.

Polymer weight-average molecular weight (M_{w}), number-average molecular weight (Mₙ) and polydispersity indices (Ð=M_{w}/Mₙ) were determined via gel permeation chromatography (GPC) relative to polystyrene standards on a PL-SEC 50 Plus instrument from Polymer Laboratories. The analysis was performed at ambient temperatures using chloroform as the eluent at a flow rate of 1.0 mL min⁻¹.

### Ligands

The following formulae illustrate the structures of pro-ligands and metal precursor compounds used for the preparation of chelate complexes in accordance with the invention

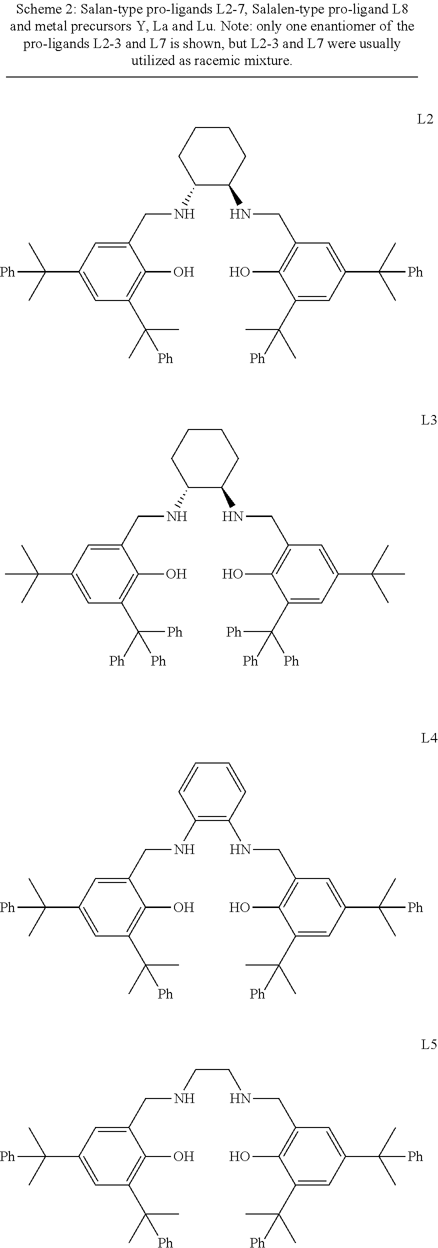 [SMILES: CC(C)(c1ccccc1)c1cc(CN[C@@H]2CCCC[C@H]2NCc2cc(C(C)(C)c3ccccc3)cc(C(C)(C)c3ccccc3)c2O)c(O)c(C(C)(C)c2ccccc2)c1 ; CC(C)(C)c1cc(CN[C@@H]2CCCC[C@H]2NCc2cc(C(C)(C)C)cc(C(c3ccccc3)(c3ccccc3)c3ccccc3)c2O)c(O)c(C(c2ccccc2)(c2ccccc2)c2ccccc2)c1 ; CC(C)(c1ccccc1)c1cc(CNc2ccccc2NCc2cc(C(C)(C)c3ccccc3)cc(C(C)(C)c3ccccc3)c2O)c(O)c(C(C)(C)c2ccccc2)c1 ; CC(C)(c1ccccc1)c1cc(CNCCNCc2cc(C(C)(C)c3ccccc3)cc(C(C)(C)c3ccccc3)c2O)c(O)c(C(C)(C)c2ccccc2)c1]

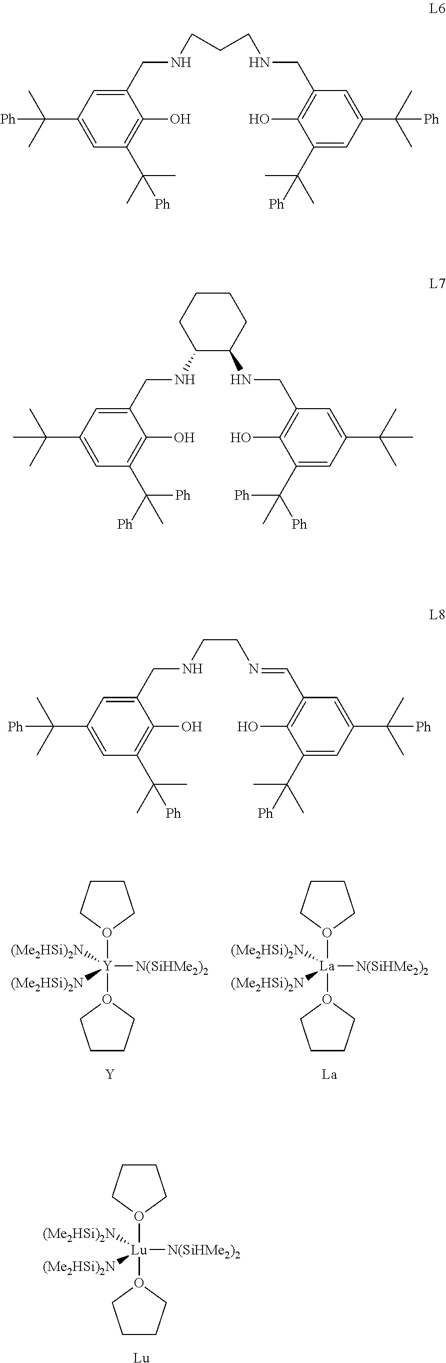

The following formulae illustrate the structures of pro-ligands used for the preparation of chelate complexes used as reference complexes and/or as synthetic intermediates.

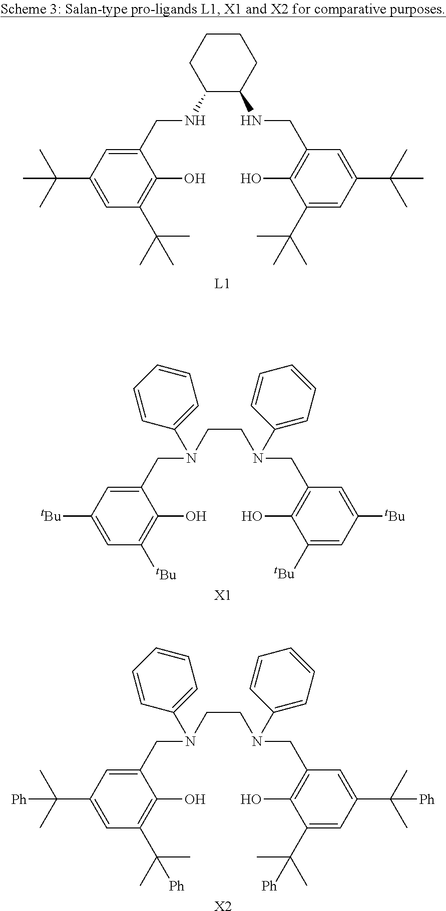 [SMILES: CC(C)(C)c1cc(CN[C@@H]2CCCC[C@H]2NCc2cc(C(C)(C)C)cc(C(C)(C)C)c2O)c(O)c(C(C)(C)C)c1 ; CC(C)(C)c1cc(CN(CCN(Cc2cc(C(C)(C)C)cc(C(C)(C)C)c2O)c2ccccc2)c2ccccc2)c(O)c(C(C)(C)C)c1 ; "X1" ; CC(C)(c1ccccc1)c1cc(CN(CCN(Cc2cc(C(C)(C)c3ccccc3)cc(C(C)(C)c3ccccc3)c2O)c2ccccc2)c2ccccc2)c(O)c(C(C)(C)c2ccccc2)c1 ; "X2"]

### Synthesis of Salan Pro-Ligands L1-L7

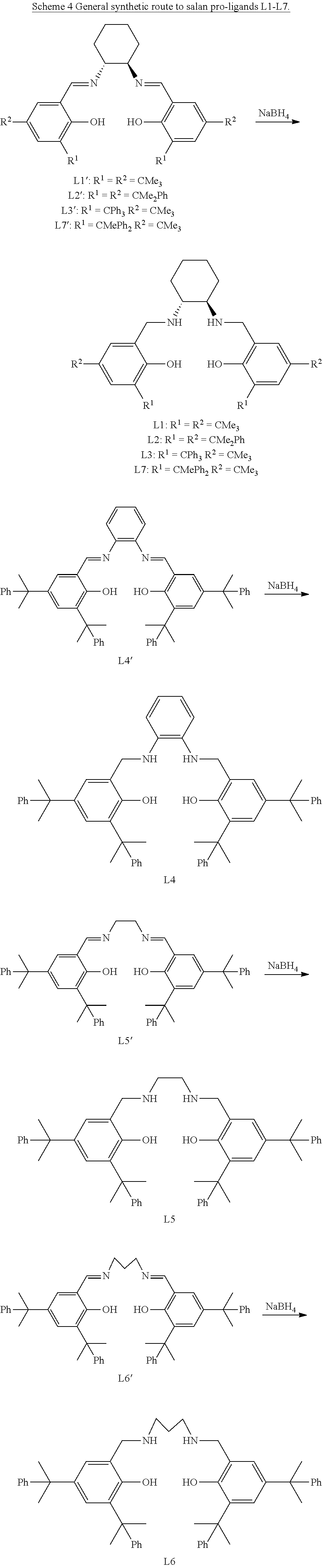

The synthesis of salan pro-ligands L1-L7 followed a similar synthetic procedure and therefore the synthesis is described as a general procedure. Using racemic or enantiopure Schiff base precursors L1′-L3′ or L7′, racemic or enantiopure salan pro-ligands are obtained in the case of L1-L3 or L7, respectively. The synthesis of L1 and L3 has previously been described in literature.^{51, 58} Schiff base precursor L5′ was prepared following an adopted literature procedure.⁴³ 3,5-Dicumylsalicylaldehyde (7.0 mmol, 2.0 eq.) was dissolved in 65 mL of ethanol, and ethylenediamine (3.5 mmol, 1.0 eq.) and 0.1 mL of formic acid was added. The mixture was refluxed for 45 min. Subsequently, the reaction mixture was cooled to room temperature, the precipitate filtered and washed with pentane. Yield: 81%, yellow solid.

Schiff base precursor L6′ was prepared according to the following procedure. 3,5-Dicumylsalicylaldehyde (10.0 mmol, 2.0 eq.) was suspended in 25 mL of methanol and 1,3-diaminopropane (5.0 mmol, 1.0 eq.) was added. The mixture was refluxed overnight. Subsequently, the reaction mixture was cooled to room temperature, the precipitate filtered and washed with methanol. Yield: 80%, yellow solid.

Schiff base precursor L7′ was prepared according to the following procedure. 5-(tert-butyl)-3-(1,1-diphenylethyl)-2-hydroxybenzaldehyde (8.0 mmol, 2.0 eq.) was suspended in 100 mL of methanol, and (±)-trans-1,2-diaminocyclohexane (4.0 mmol, 1.0 eq.) and 0.1 mL of formic acid was added. The mixture was refluxed for 5 h. Subsequently, the reaction mixture was cooled to room temperature, the precipitate filtered and washed with methanol. Yield: 81%, yellow solid.

General procedure for L1-L7. The bis-imine type precursor (salen-type pro-ligand) (6.0 mmol, 1 eq.) was dissolved in 25 mL of tetrahydrofuran and 25 mL of methanol. The reaction mixture was cooled to 0° C. and sodium borohydride, NaBH₄ (60.0 mmol, 10 eq.) was added portionwise. Subsequently, the reaction mixture was allowed to warm to room temperature and stirred for 3 h at this temperature. The solvent was removed under reduced pressure, the residue dissolved in dichloromethane (250 mL) and water (125 mL) was added.

The phases were separated, and the organic layer washed with water (2×75 mL) and brine (1×75 mL). The organic layer was dried over Na₂SO₄, the solvent removed under reduced pressure and the residue further purified as described below.

Salan pro-ligand L1: The residue was recrystallized from methanol/dichloromethane. Yield: 80%, colorless solid.

¹H NMR (400 MHz, CDCl₃): δ 10.64 (br s, 2H, OH), 7.21 (d, J=2.5 Hz, 2H, Ar—H), 6.86 (d, J=2.5 Hz, 2H, Ar—H), 3.97 (AB, J=13.4 Hz, 4H, N—CH₂), 2.51-2.43 (m, 2H, Cy), 2.23-2.13 (m, 2H, Cy), 1.76-1.68 (m, 2H, Cy), 1.38 (s, 18H, ^{t}Bu), 1.28 (s, 18H, ^{t}Bu), 1.27-1.21 (m, 4H, Cy). ¹³C{¹H}NMR (101 MHz, CDCl₃): δ 154.5, 140.8, 136.1, 123.3, 123.2, 122.5, 60.1, 51.0, 35.0, 34.3, 31.8, 30.9, 29.8, 24.3. Anal. Calc. for C₃₆H₅₈N₂O₂: C, 78.49; H, 10.61; N, 5.09. Found: C, 77.43; H, 10.33; N, 5.06%.

Salan pro-ligand L2: The residue was washed with methanol. Yield: 86%, colorless solid. ¹H NMR (400 MHz, CDCl₃): δ 10.38 (br s, 2H, OH), 7.31-7.23 (m, 10H, Ar—H), 7.20-7.08 (m, 10H, Ar—H), 7.05-6.99 (m, 2H, Ar—H), 6.64 (d, J=2.5 Hz, 2H, Ar—H), 3.64 (AB, J=13.5 Hz, 4H, N—CH₂), 1.87-1.79 (m, 2H, Cy), 1.71 (s, 6H, CMe₂Ph), 1.69 (s, 12H, CMe₂Ph), 1.68-1.63 (m, 2H, Cy), 1.57 (s, 6H, CMe₂Ph), 1.55-1.50 (m, 2H, Cy), 0.98-0.83 (m, 2H, Cy), 0.71-0.51 (m, 4H, Cy and NH). ¹³C{¹H}NMR (101 MHz, CDCl₃): δ 154.0, 152.1, 151.7, 139.8, 135.4, 128.0, 127.6, 126.9, 125.9, 125.7, 125.5, 124.6, 124.3, 122.1, 58.0, 49.3, 42.6, 42.0, 31.3, 31.2, 30.9, 30.1, 28.0, 24.6. Anal. Calc. for C₅₆H₆₆N₂O₂: C, 84.17; H, 8.32; N, 3.51. Found: C, 83.89; H, 8.45; N, 3.55%.

Salan pro-ligand L3: The residue was washed with methanol. Yield: 74%, colorless solid.

¹H NMR (400 MHz, CDCl₃): δ 10.30 (br s, 2H, OH), 7.23-7.08 (m, 30H, Ar—H), 7.05 (d, J=2.5 Hz, 2H, Ar—H), 6.83 (d, J=2.6 Hz, 2H, Ar—H), 3.72 (AB, J=13.8 Hz, 4H, N—CH₂), 1.83-1.73 (m, 2H, Cy), 1.56-1.44 (m, 4H, Cy), 1.13 (s, 18H, ^{t}Bu), 0.89-0.78 (m, 2H, Cy), 0.63-0.43 (m, 4H, Cy and NH). ¹³C{¹H}NMR (101 MHz, CDCl₃): δ 154.1, 146.3, 140.1, 133.3, 131.4, 127.5, 127.0, 125.5, 124.3, 121.9, 63.5, 57.9, 49.3, 34.2, 31.7, 29.9, 24.7. Anal. Calc. for C₆₆H₇₀N₂O₂: C, 85.86; H, 7.64; N, 3.03. Found: C, 85.74; H, 7.80; N, 3.16%.

Salan pro-ligand L4: L4 was prepared according to the general procedure but the stirring time of the reaction mixture was 4 h at room temperature. The residue was washed with methanol. Yield: 84%, yellow solid.

¹H NMR (400 MHz, CDCl₃): δ 7.31-7.27 (m, 10H, Ar—H), 7.23-7.15 (m, 10H, Ar—H), 7.14-7.08 (m, 2H, Ar—H), 6.95 (br s, 2H, OH), 6.92 (d, J=2.4 Hz, 2H, Ar—H), 6.80-6.75 (m, 2H, Ar—H), 6.70-6.64 (m, 2H, Ar—H), 4.11 (s, 4H, N—CH₂), 3.40 (br s, 2H, NH), 1.71 (s, 12H, CMe₂Ph), 1.62 (s, 12H, CMe₂Ph). ¹³C{¹H}NMR (101 MHz, CDCl₃): δ 152.1, 151.2, 150.4, 141.7, 136.9, 135.5, 128.4, 128.1, 126.9, 126.5, 125.8, 125.8, 125.7, 125.2, 123.8, 121.0, 114.0, 47.6, 42.7, 42.2, 31.2, 29.8. Anal. Calc. for C₅₆H₆₀N₂O₂: C, 84.81; H, 7.63; N, 3.53. Found: C, 84.76; H, 7.82; N, 3.37%.

Salan pro-ligand L5: The residue was washed with methanol. Yield: 69%, off-white solid.

¹H NMR (400 MHz, CDCl₃): δ 10.37 (br s, 2H, OH), 7.33-7.27 (m, 8H, Ar—H), 7.24 (d, J=2.6 Hz, 2H, Ar—H), 7.21-7.14 (m, 10H, Ar—H), 7.11-7.04 (m, 2H, Ar—H), 6.70 (d, J=2.5 Hz, 2H, Ar—H), 3.71 (s, 4H, Ar—CH₂), 2.43 (s, 4H, N—CH₂), 1.70 (s, 12H, CMe₂Ph), 1.65 (s, 12H, CMe₂Ph). ¹³C{¹H}NMR (101 MHz, CDCl₃): δ 154.0, 151.7, 151.5, 140.0, 135.4, 128.0, 127.7, 126.9, 125.8, 125.6, 125.5, 124.9, 124.9, 121.9, 53.1, 47.6, 42.6, 42.1, 31.2, 29.6.

Salan pro-ligand L6: The residue was recrystallized from methanol. Yield: 51%, colorless solid.

¹H NMR (400 MHz, CDCl₃): δ 7.29-7.26 (m, 8H, Ar—H), 7.22 (d, J=2.5 Hz, 2H, Ar—H), 7.20-7.14 (m, 10H, Ar—H), 7.10-7.04 (m, 2H, Ar—H), 6.70 (d, J=2.5 Hz, 2H, Ar—H), 3.72 (s, 4H, Ar—CH₂), 2.40 (t, J=6.8 Hz, 4H, N—CH₂CH₂CH₂—N), 1.68 (s, 12H, CMe₂Ph), 1.63 (s, 12H, CMe₂Ph), 1.39 (p, J=7.0 Hz, 2H, N—CH₂CH₂CH₂—N). ¹³C{¹H}NMR (101 MHz, CDCl₃): δ 154.2, 151.6, 151.5, 140.0, 135.4, 128.0, 127.8, 126.9, 125.8, 125.6, 125.4, 125.0, 124.9, 122.2, 53.3, 46.5, 42.6, 42.2, 31.2, 29.7, 29.5. Anal. Calc. for C₅₃H₆₂N₂O₂: C, 83.86; H, 8.23; N, 3.69. Found: C, 83.84; H, 8.21; N, 3.70%.

Salan pro-ligand L7: The residue was washed with methanol. Yield: 62%, off-white solid.

¹H NMR (400 MHz, CDCl₃): δ 7.27-7.10 (m, 20H, Ar—H), 6.84 (d, J=2.5 Hz, 2H, Ar—H), 6.56 (d, J=2.5 Hz, 2H, Ar—H), 3.84 (AB, J=13.8 Hz, 4H, N—CH₂), 2.28 (s, 6H, CMePh₂), 2.12-1.97 (m, 4H, Cy), 1.68-1.57 (m, 2H, Cy), 1.18-1.03 (m, 2H, Cy), 1.11 (s, 18H, ^{t}Bu), 0.99-0.85 (m, 2H, Cy). ¹³C{1H}NMR (101 MHz, CDCl₃): δ 154.0, 149.1, 149.0, 140.2, 135.0, 128.7, 128.6, 127.7, 127.7, 127.1, 125.7, 125.6, 123.8, 122.3, 59.4, 52.0, 50.3, 34.1, 31.6, 30.8, 27.8, 24.5.

### Synthesis of Salalen Pro-Ligand L8

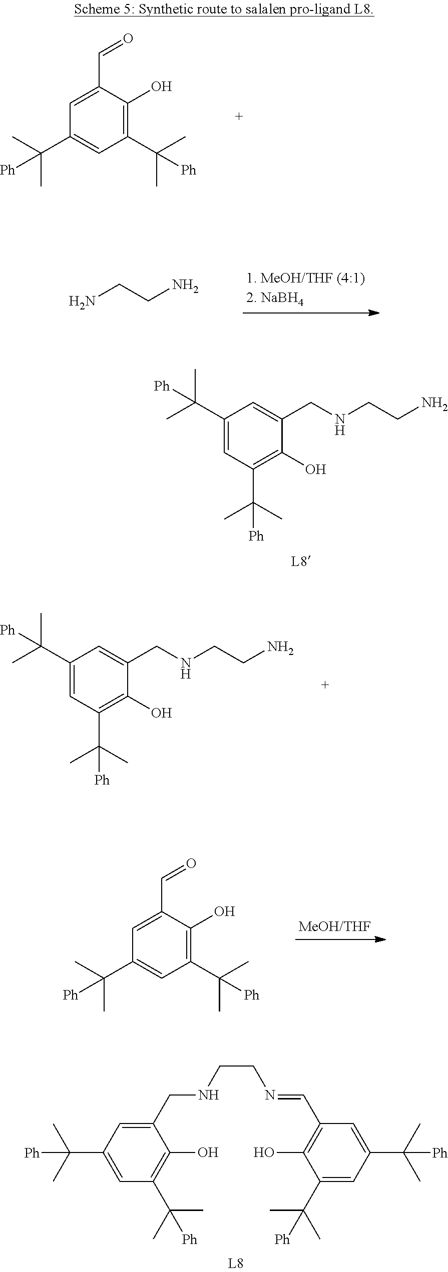

Precursor L8′ was prepared following an adapted literature procedure (Catal. Sci. Technol., 2014, 4, 3964). Ethylenediamine (5.6 mmol, 1.0 eq.) was dissolved in 40 mL of methanol and 3,5-dicumylsalicylaldehyde (5.6 mmol, 1.0 eq.) dissolved in 50 mL of methanol/THF (4:1) was added dropwise. The resulting suspension was stirred for 20 h at room temperature and afterwards cooled to 0° C. Sodium borohydride, NaBH₄ (55.8 mmol, 10 eq.) was added portionwise, and then stirred for 2 h. Subsequently, the reaction mixture was allowed to warm to room temperature and stirred overnight at this temperature. The solvent was removed under reduced pressure, the residue dissolved in dichloromethane (250 mL) and water (125 mL) was added. The phases were separated, and the organic layer washed with water (2×75 mL) and brine (1×75 mL). The organic layer was dried over Na₂SO₄, the solvent removed under reduced pressure and the residue recrystallized from methanol. The crystalized white solid was found to be the side product L5 while the filtrate contained, after removal of the solvent the targeted precursor L8′ with good purity. Yield: 47%, colorless solid.

¹H NMR (400 MHz, CDCl₃): δ 7.32-7.15 (m, 11H, Ar—H), 6.72 (d, J=2.5 Hz, 1H, Ar—H), 3.81 (s, 2H, HN—CH₂), 2.71-2.64 (m, 2H, HN—CH₂), 2.57-2.00 (m, 2H, H₂N—CH₂), 1.67 (s, 6H, CMe₂Ph), 1.64 (s, 6H, CMe₂Ph).

Salalen pro-ligand L8: The half-salan type precursor L8′ (2.75 mmol, 1.0 eq.) was dissolved in 40 mL of methanol and 3,5-dicumylsalicylaldehyde (2.75 mmol, 1.0 eq.) dissolved in 20 mL of methanol was added at room temperature and stirred for 24 h. Subsequently, the precipitate was filtered and washed with methanol. The residue was recrystallized from methanol/dichloromethane. Yield: 71%, yellow solid.

¹H NMR (400 MHz, CDCl₃): δ 13.99 (br s, 1H, OH), 10.46 (br s, 1H, OH), 8.10 (s, 1H, N═CH), 7.35 (d, J=2.4 Hz, 1H, Ar—H), 7.32-7.05 (m, 21H, Ar—H), 6.99 (d, J=2.4 Hz, 1H, Ar—H), 6.71 (d, J=2.4 Hz, 1H, Ar—H), 3.77 (s, 2H, NH—CH₂), 3.42 (t, J=5.8 Hz, 2H, N—CH₂), 2.72 (t, J=5.8 Hz, 2H, HN—CH₂), 1.71 (s, 6H, CMe₂Ph), 1.67 (s, 6H, CMe₂Ph), 1.65 (s, 6H, CMe₂Ph), 1.63 (s, 6H, CMe₂Ph). ¹³C{¹H}NMR (101 MHz, CDCl₃): δ 167.5, 157.6, 153.9, 151.5, 151.4, 150.8, 150.7, 140.2, 140.0, 136.2, 135.5, 129.3, 128.2, 128.1, 128.0, 127.9, 127.8, 126.9, 126.8, 125.8, 125.7, 125.7, 125.6, 125.5, 125.2, 125.1, 125.0, 121.9, 118.0, 58.9, 52.6, 47.9, 42.5, 42.5, 42.1, 42.0, 31.1, 30.9, 29.6, 29.5. Anal. Calc. for C₅₂H₅₈N₂O₂: C, 84.06; H, 7.87; N, 3.77. Found: C, 83.97; H, 8.07; N, 3.76%.

### Example 1: Synthesis of Salan Catalyst 1

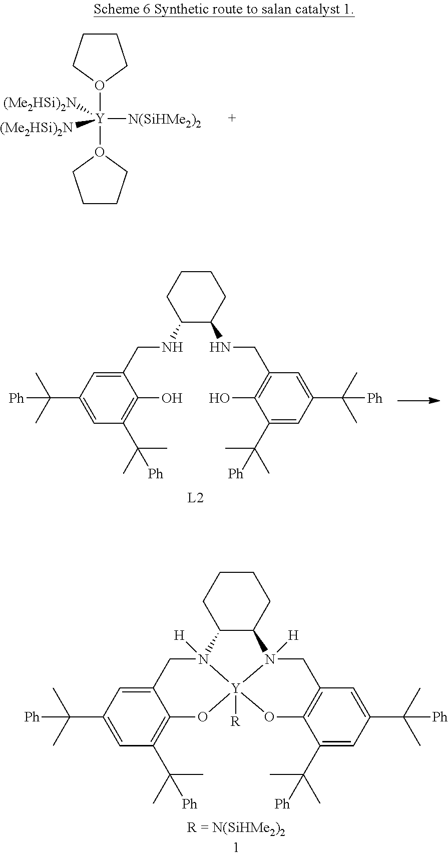

To a solution of Y[N(SiHMe₂)₂]₃(THF)₂ (126 mg, 200 μmol, 1 eq.) in 5 mL of toluene, a solution of L2 in 5 mL of toluene was added. The reaction mixture was stirred for 2 h at room temperature. The solvent was removed to afford 1 as an off-white solid.

LIFDI-MS: [(L2)Y]⁺ (m/z 885.40, calc. 885.40), [(L2)Y(N(SiHMe₂)₂)]⁺ (m/z 1017.46, calc. 1017.47).

### Example 2: General Polymerization Procedure Using In Situ Formed Catalysts

In an inert atmosphere glovebox, a 20 mL glass reactor was charged with a predetermined amount of Y[N(SiHMe₂)₂]₃(THF)₂ (1 eq.) and salan or salalen pro-ligand (1 eq.) such as L1-L8. The respective amount of toluene was added such that the overall monomer concentration after rac-BBL addition is 2.0M. The reaction mixture was stirred for 1 h at room temperature and then, rac-BBL (equivalents as specified in the polymerization table) was added to this mixture. After stirring for a desired time period at room temperature, the polymerization was quenched by the addition of 0.5 mL of methanol. An aliquot sample was taken for determination of conversion by ¹H NMR spectroscopy. The quenched mixture was then precipitated into 20 mL of diethyl ether/pentane (1/1), filtered, washed with diethyl ether/pentane (1/1) and dried in vacuo.

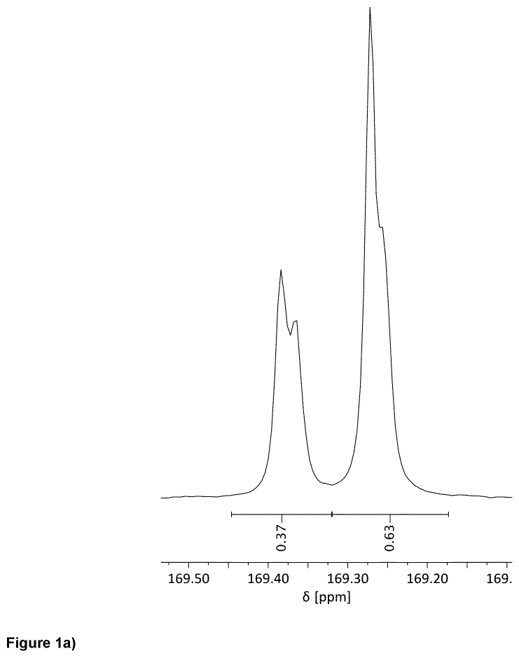

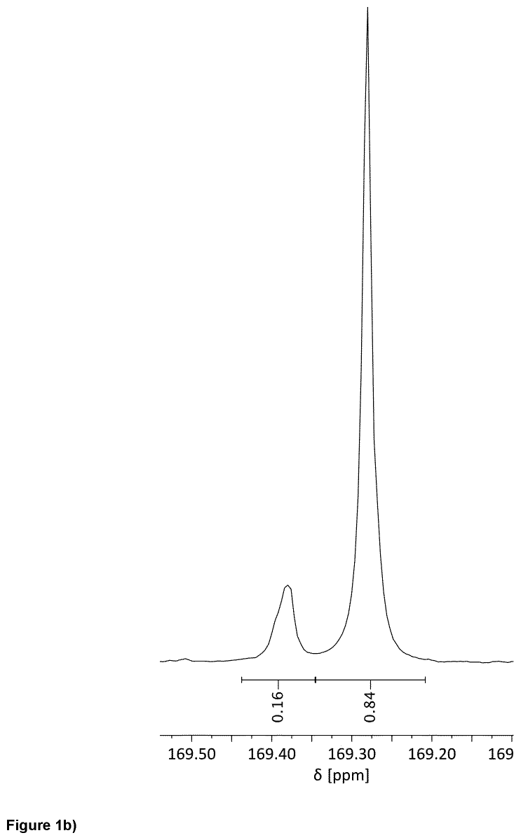

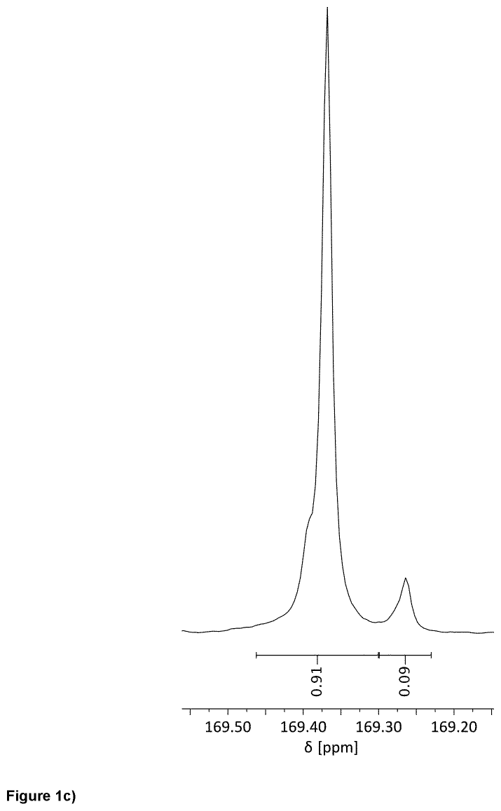

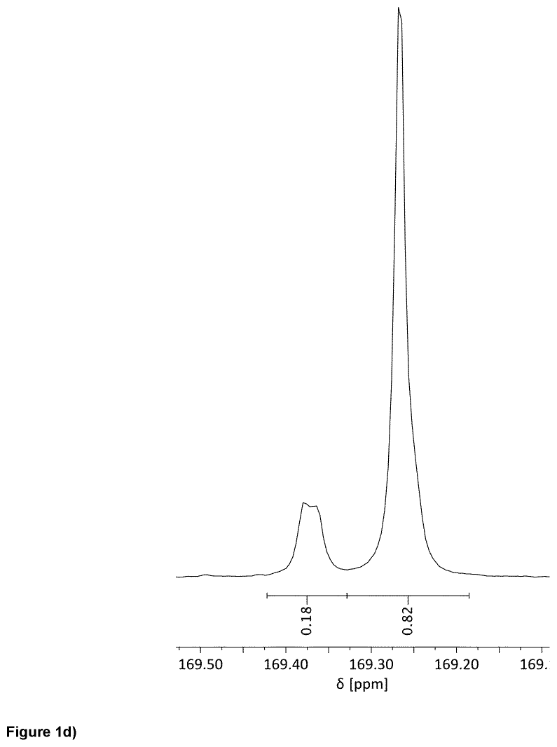

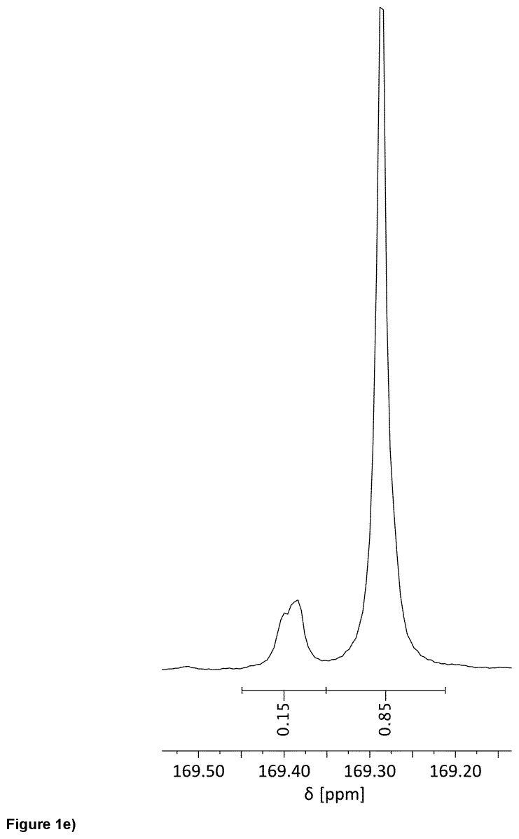

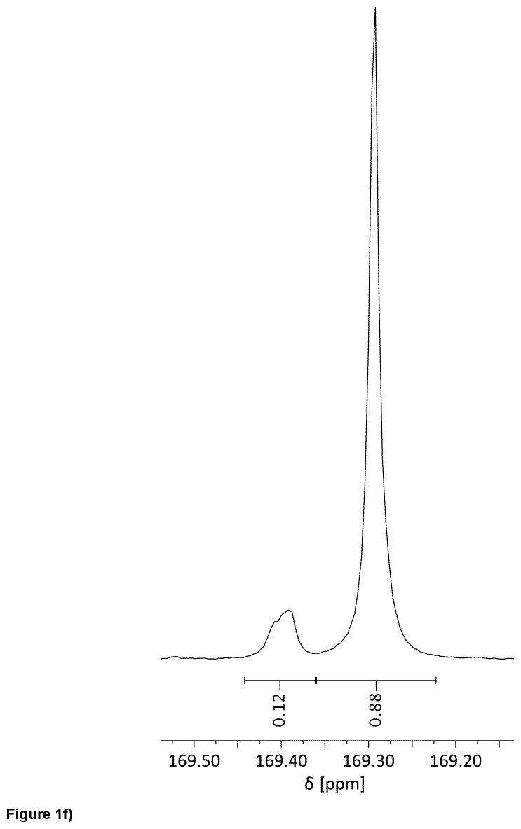

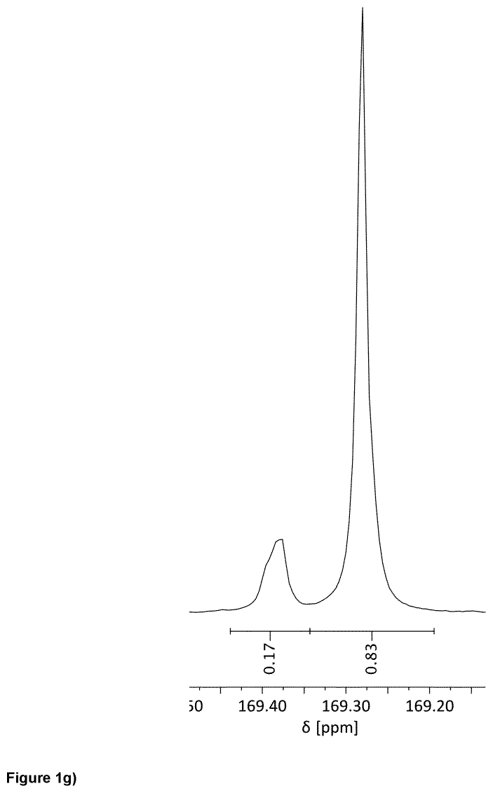

FIG. 1 shows the 13C NMR carbonyl regions of the PHBs produced by the polymerization approach described in Example 2. a) Y[N(SiHMe₂)₂]₃(THF)₂+L1 (Table 2, entry 1), b) Y[N(SiHMe₂)₂]₃(THF)₂+L2 (Table 1, entry 3), c) Y[N(SiHMe₂)₂]₃(THF)₂+L3 (Table 1, entry 9), d) Y[N(SiHMe₂)₂]₃(THF)₂+L4 (Table 1, entry 10), e) Y[N(SiHMe₂)₂]₃(THF)₂+L5 (Table 1, entry 11), f) Y[N(SiHMe₂)₂]₃(THF)₂+L6 (Table 1, entry 12), g) Y[N(SiHMe₂)₂]₃(THF)₂+L7 (Table 1, entry 16),

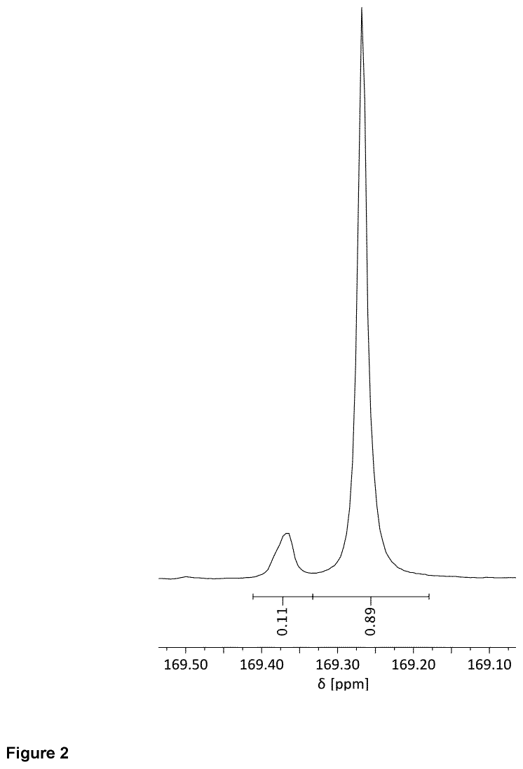

FIG. 2 shows the ¹³C NMR carbonyl region of the PHB produced by the polymerization approach described in Example 2 at a polymerization temperature of −35° C., Y[N(SiHMe₂)₂]₃(THF)₂+L2 (Table 1, entry 6).

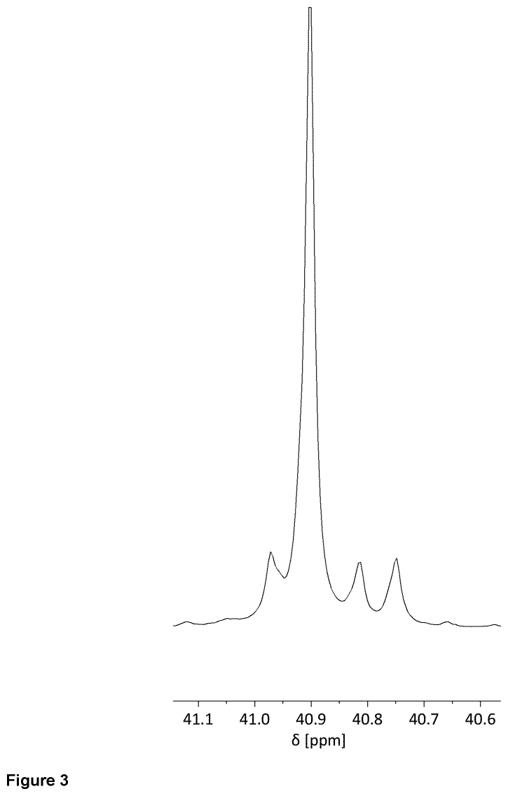

FIG. 3 shows the ¹³C NMR methylene region of the PHB produced by the polymerization approach described in Example 2. Y[N(SiHMe₂)₂]₃(THF)₂+L2 (Table 1, entry 3).

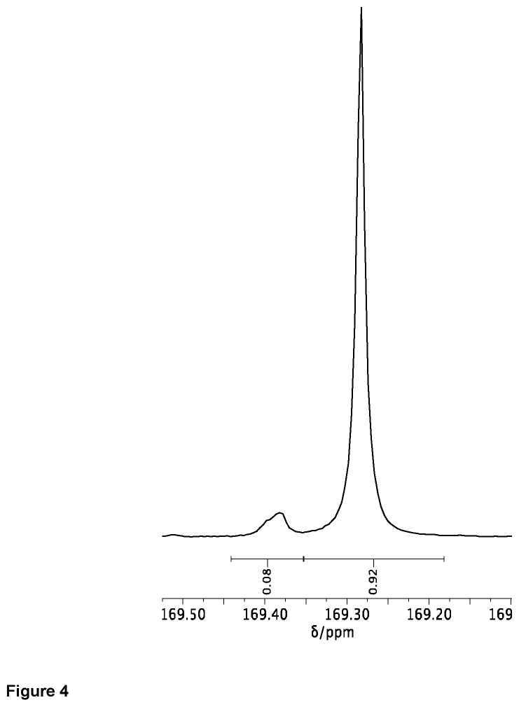

FIG. 4 shows the ¹³C NMR carbonyl region of the PHB produced by the catalyst system Y[N(SiHMe₂)₂]₃(THF)₂+L8.

### Example 3: Polymerization Procedure Using Isolated Catalyst

In an inert atmosphere glovebox, a 5 mL glass reactor was charged with catalyst 1 (18.6 mg, 18.3 μmol, 1 eq.) as prepared in Example 2 and 1.53 mL of toluene was added. The mixture was stirred for 5 min at room temperature and then, the polymerization was initiated by rapid addition of rac-BBL (315.0 mg, 3.7 mmol, 200 eq.). After stirring for a desired time period at room temperature, the polymerization was quenched by the addition of 0.5 mL of methanol. An aliquot sample was taken for determination of conversion by ¹H NMR spectroscopy. The quenched mixture was then precipitated into 10 mL of diethyl ether/pentane (1/1), filtered, washed with diethyl ether/pentane (1/1) and dried in vacuo.

### Example 4: Polymerization Procedure Using In Situ Formed Catalysts and Benzyl Alcohol as Initiator

In an inert atmosphere glovebox, a 5 mL glass reactor was charged with a predetermined amount of Y[N(SiHMe₂)₂]₃(THF)₂ (5.8 mg, 9.2 μmol, 1 eq.) and salan pro-ligand L2 (7.3 mg, 9.2 μmol, 1 eq.). The respective amount of toluene was added such that the overall monomer concentration after rac-BBL addition is 2.0M. The reaction mixture was stirred for 1 h at room temperature and then, a predetermined amount of a BnOH stock solution in toluene was added (eq. of BnOH as specified in the polymerization table) and the mixture stirred for an additional 5 min at room temperature. The polymerization was initiated by rapid addition of rac-BBL (315.0 mg, 3.7 mmol, 400 eq.). After stirring for a desired time period at room temperature, the polymerization was quenched by the addition of 0.5 mL of methanol. An aliquot sample was taken for determination of conversion by ¹H NMR spectroscopy. The quenched mixture was then precipitated into 10 mL of diethyl ether/pentane (1/1), filtered, washed with diethyl ether/pentane (1/1) and dried in vacuo.

### Results of Polymerization Examples Using Salan Catalysts

The following table 1 summarizes the polymerization examples using the chelate complexes of the invention and their results.

TABLE 1
Polymerization data for ROP of rac-BBL
using the process described above.^{a}

| | | | T | | | Mₙ ^{c} | | |
|---|---|---|---|---|---|---|---|---|
| | catalytic | [MM]/ | (° | t | conv.^{b} | (kg/ | | |
| entry | system | [L + Y] | C.) | (min) | (%) | mol) | Ð ^{c} | Pₘ ^{d} |
| 1 | L2 + Y | 200 | rt. | 1 | 98 | 41 | 2.2 | 0.82 |
| 2 | L2 + Y | 400 | rt. | 2 | 99 | 85 | 2.0 | 0.83 |
| 3 | L2 + Y | 2000 | rt. | 3 | 80 | 290 | 2.0 | 0.84 |
| 4 | L2 + Y | 3000 | rt. | 10 | 85 | 445 | 1.8 | 0.75 |
| 5 | L2 + Y | 4000 | rt. | 60 | 88 | 565 | 1.7 | 0.71 |
| 6 | L2 + Y | 200 | −35 | 60 | >99 | 130 | 3.2 | 0.89 |
| 7^{e} | L2 + Y | 400 | rt. | 1 | 99 | 60 | 1.9 | 0.75 |
| 8^{f} | L2 + Y | 400 | rt. | 30 | 100 | 12 | 1.1 | 0.62 |
| 9 | L3 + Y | 200 | rt. | 3 | 99 | 43 | 3.5 | 0.09 |
| 10 | L4 + Y | 200 | rt. | 30 | 52 | 103 | 1.8 | 0.82 |
| 11 | L5 + Y | 200 | rt. | 3 | 91 | 77 | 2.1 | 0.85 |
| 12 | L6 + Y | 200 | rt. | 3 | 55 | 184 | 1.9 | 0.88 |
| 13 | L2 + La | 200 | rt. | 30 | 32 | n.d. | n.d. | 0.61 |
| 14 | L2 + Lu | 200 | rt. | 1 | 97 | 67 | 1.8 | 0.82 |
| 15^{g} | L2 + Y | 200 | rt. | 1 | 97 | 45 | 1.8 | 0.81 |
| | (1) | | | | | | | |
| 16 | L7 + Y | 200 | rt. | 1 | 99 | 47 | 1.9 | 0.83 |

^{a}Catalyst was prepared in situ by treatment of Y(bdsa)₃(THF)₂ (Y), La(bdsa)₃(THF)₂ (La) or Lu(bdsa)₃(THF)₂ (Lu) with salan pro-ligand L (1 eq.) in toluene at room temperature (rt.) for 1 h prior to addition of monomer (MM), [MM]/[L + Y] indicates the molar ratio of monomer to the complex formed in situ from Y (or La, Lu) and L (Protocol Example 2). [BBL] = 2.0M.
^{b}Conversion determined by ¹H NMR spectroscopy.
^{c} Molecular weight and dispersity of polymer determined by GPC in CHCl₃ at rt. relative to polystyrene standards.
^{d} Tacticity determined by ¹³C NMR spectroscopy, integration of the carbonyl signal.
^{e}1 eq. of BnOH added prior to monomer addition.
^{f}5 eq. of BnOH added prior to monomer addition.
^{g}Isolated catalyst used for polymerization run (Example 3).
n.d. = not determined.

Using L2 and metal precursor Y(bdsa)₃(THF)₂ (Y, bdsa=bis(dimethylsilyl)amide) in the in situ protocol (Example 2), iso-enriched PHB with Pₘ=0.82 was obtained (Table 1, entry 1). The activity of catalyst system L2+Y was also further improved (TOF up to 32 000 h⁻¹). Gradually increasing the [M]/[L2+Y] ratio up to 4000/1 was feasible and iso-enriched PHB with very high molecular weight could be obtained (Table 1, entries 2-5). Decreasing the polymerization temperature to −35° C. increased the stereoselectivity of the process and PHB with a Pₘ=0.89 was isolated (Table 1, entry 6). Addition of various equivalents of benzyl alcohol (BnOH) to the in situ formed catalyst species prior to monomer addition gave PHB with reduced isotacticity with increasing amount of BnOH equivalents (Table 1, entries 7 and 8). Thus, control over the degree of isotacticity is also feasible using additives such as alcohols in this catalyst/polymerization system. Switching the ortho-substituent of the pro-ligand to a sterically more demanding trityl group (CPh₃, L3), the stereocontrol in ROP of rac-BBL with L3+Y switched to high syndioselectivity (Pᵣ=0.91; Table 1, entry 9). Highly iso-enriched PHB could also be accessed by catalyst systems consisting of L4+Y, L5+Y or L6+Y (Table 1, entries 10-12), showing that the use of a chiral backbone is not necessary for achieving high stereocontrol. The approach described herein could also be extended to the use of different metal precursors. For example, using L2 and a lanthanum precursor such as La(bdsa)₃(THF)₂ (La), iso-enriched PHB was accessible (Pₘ=0.61; Table 1, entry 13). Regarding the ROP of rac-BBL using isolated salan-type catalysts (Protocol Example 3), virtually identical polymerization outcomes were observed compared to the ones using the protocol of Example 2 (Table 1, entry 15).

Catalyst system L2+Y shows the highest activity for the isoselective production of PHB reported to date. Additionally, the achieved isoselectivity of Pₘ=0.89 at a reaction temperature of −35° C. is the highest reported to date for the ROP of rac-BBL. It is worth noting here, that the yttrium salen-based catalyst system reported by Chen et al. showing very high isoselectivity in the ROP of the eight-membered diolide was not able to induce stereocontrol in the ROP of rac-BBL.⁴³ This highlights the importance of the presence of an amine moiety in the ligand/catalyst structure.

The following table 2 summarizes the polymerization examples using reference chelate complexes for comparative purposes.

TABLE 2
Polymerization data for ROP of rac-BBL.

| | | | T | | | Mₙ ^{c} | | |
|---|---|---|---|---|---|---|---|---|
| | catalytic | [MM]/ | (° | t | conv.^{b} | (kg/ | | |
| entry | system | [L + Y] | C.) | (min) | (%) | mol) | Ð ^{c} | Pₘ ^{d} |
| 1 | L1 + Y | 200 | rt. | 120 | 83 | 35 | 1.9 | 0.63 |
| 2 | X1 + Y | 200 | rt. | 15 | 59 | 23 | 1.5 | 0.63 |
| 3 | X2 + Y | 200 | rt. | 30 | 76 | 24 | 1.4 | 0.67 |
| 4 | L1′ + Y | 200 | rt. | 1440 | 22 | 8 | 1.9 | 0.50 |
| 5 | L2′ + Y | 200 | rt. | 1440 | 20 | 9 | 1.8 | 0.51 |
| 6 | L3′ + Y | 200 | rt. | 1440 | 8 | n.d. | n.d. | 0.55 |
| 7 | L4′ + Y | 200 | rt. | 1440 | 2 | n.d. | n.d. | n.d. |

^{a}Catalyst was prepared in situ by treatment of Y(bdsa)₃(THF)₂ (Y) with salan or salen pro-ligand X or L (1 eq.) in toluene at room temperature (rt.) for 1 h prior to addition of monomer (Protocol Example 2). [BBL] = 2.0M.
^{b}Conversion determined by ¹H NMR spectroscopy.
^{c} Molecular weight and dispersity of polymer determined by GPC in THF at 40° C. relative to polystyrene standards.
^{d} Tacticity determined by ¹³C NMR spectroscopy, integration of the carbonyl signal.
n.d. = not determined.

### Polymerization Results Using In Situ Prepared Salalen Catalyst

TABLE 3
Polymerization data for ROP of rac-BBL.

| | catalytic | [MM]/ | T | t | conv.^{b} | Mₙ ^{c} | | |
|---|---|---|---|---|---|---|---|---|
| entry | system | [L + Y] | (° C.) | (min) | (%) | (kg/mol) | Ð ^{c} | Pₘ ^{d} |
| 1 | L8 + Y | 200 | rt. | 15 | 60 | 49 | 1.7 | 0.92 |

^{a}Catalyst was prepared in situ by treatment of Y(bdsa)₃(THF)₂ (Y) with salalen pro-ligand L8 (1 eq.) in toluene at room temperature (rt.) for 1 h prior to addition of monomer (MM), [MM]/[L8 + Y] indicates the molar ratio of monomer to the complex formed in situ from Y and L8 (Protocol Example 2). [BBL] = 2.0M.
^{b}Conversion determined by ¹H NMR spectroscopy.
^{c} Molecular weight and dispersity of polymer determined by GPC in CHCl₃ at rt. relative to polystyrene standards.
^{d} Tacticity determined by ¹³C NMR spectroscopy, integration of the carbonyl signal.

### REFERENCES

1. Muhammadi, Shabina, M. Afzal and S. Hameed, Green Chem. Lett. Rev., 2015, 8, 56-77.
2. R. Reichardt and B. Rieger, in Synthetic Biodegradable Polymers, Springer, 2011, pp. 49-90.
3. N. Tanahashi and Y. Doi, Macromolecules, 1991, 24, 5732-5733.
4. H. Abe and Y. Doi, Macromolecules, 1996, 29, 8683-8688.
5. J. C. Worch, H. Prydderch, S. Jimaja, P. Bexis, M. L. Becker and A. P. Dove, Nat. Rev. Chem., 2019, 3, 514-535.
6. E. Gabirondo, A. Sangroniz, A. Etxeberria, S. Torres-Giner and H. Sardon, Polym. Chem., 2020, 11, 4861-4874.
7. V. Mahadevan, Y. D. Getzler and G. W. Coates, Angew. Chem., 2002, 114, 2905-2908.
8. G. A. Olah, A. Goeppert and G. S. Prakash, J. Org. Chem., 2008, 74, 487-498.
9. X. Zuwei, Z. Ning, S. Yu and L. Kunlan, Science, 2001, 292, 1139-1141.
10. Z. Jedliski, P. Kurcok and R. W. Lenz, Macromolecules, 1998, 31, 6718-6720.
11. M. Haslböck, M. Klotz, L. Steiner, J. Sperl, V. Sieber, C. Zollfrank and D. Van Opdenbosch, Macromolecules, 2018, 51, 5001-5010.
12. C. M. Thomas, Chem. Soc. Rev., 2010, 39, 165-173.
13. L. R. Rieth, D. R. Moore, E. B. Lobkovsky and G. W. Coates, J. Am. Chem. Soc., 2002, 124, 15239-15248.
14. J. F. Carpentier, Macromol. Rapid Commun., 2010, 31, 1696-1705.
15. C. M. Thomas, Chem. Soc. Rev., 2010, 39, 165-173.
16. M. J. Tschan, R. M. Gauvin and C. M. Thomas, Chem. Soc. Rev., 2021, 50, 13587-13608.
17. J. F. Carpentier, Macromol. Rapid. Commun., 2010, 31, 1696-1705.
18. A. Amgoune, C. M. Thomas, S. Ilinca, T. Roisnel and J. F. Carpentier, Angew. Chem. Int. Ed., 2006, 45, 2782-2784.
19. J.-F. Carpentier, Organometallics, 2015, 34, 4175-4189.
20. M. Bouyahyi, N. Ajellal, E. Kirillov, C. M. Thomas and J. F. Carpentier, Chem. Eur. J., 2011, 17, 1872-1883.
21. N. Ajellal, M. Bouyahyi, A. Amgoune, C. M. Thomas, A. Bondon, I. Pillin, Y. Grohens and J.-F. Carpentier, Macromolecules, 2009, 42, 987-993.
22. D. Agostini, J. Lando and J. R. Shelton, J. Polym. Sci. Part A-1: Polym. Chem., 1971, 9, 2775-2787.
23. K. Teranishi, M. Iida, T. Araki, S. Yamashita and H. Tani, Macromolecules, 1974, 7, 421-427.
24. M. Iida, T. Araki, K. Teranishi and H. Tani, Macromolecules, 1977, 10, 275-284.
25. R. A. Gross, Y. Zhang, G. Konrad and R. W. Lenz, Macromolecules, 1988, 21, 2657-2668.
26. S. Bloembergen, D. A. Holden, T. L. Bluhm, G. K. Hamer and R. H. Marchessault, Macromolecules, 1989, 22, 1656-1663.
27. C. Jaimes, M. Arcana, A. Brethon, A. Mathieu, F. Schue and J. Desimone, Eur. Polym. J., 1998, 34, 175-186.
28. B. Wu and R. W. Lenz, Macromolecules, 1998, 31, 3473-3477.
29. A. Le Borgne and N. Spassky, Polymer, 1989, 30, 2312-2319.
30. M. Zinti, F. Molnar, T. Urban, V. Bernhart, P. Preishuber-Pflügl and B. Rieger, Angew. Chem. Int. Ed., 2008, 47, 3458-3460.
31. P. Preishuber-Pflügl and F. Molnar, 2006, WO 2006/108829 A2.
32. R. Reichardt, S. Vagin, R. Reithmeier, A. K. Ott and B. Rieger, Macromolecules, 2010, 43, 9311-9317.
33. N. Ajellal, G. Durieux, L. Delevoye, G. Tricot, C. Dujardin, C. M. Thomas and R. M. Gauvin, Chem. Commun., 2010, 46, 1032-1034.
34. M. Terrier, E. Brule, M. J. Vitorino, N. Ajellal, C. Robert, R. M. Gauvin and C. M. Thomas, Macromol. Rapid Commun., 2011, 32, 215-219.
35. Z. Zhuo, C. Zhang, Y. Luo, Y. Wang, Y. Yao, D. Yuan and D. Cui, Chem. Commun., 2018, 54, 11998-12001.
36. X. Dong and J. R. Robinson, Chem. Sci., 2020, 11, 8184-8195.
37. X. Dong, A. M. Brown, A. J. Woodside and J. R. Robinson, Chem. Commun., 2022, 58, 2854-2857.
38. J. R. Robinson and X. Dong, 2021, US 2021/0188878 A1.
39. F. Adams and B. Rieger, 2020, US 2020/0354515 A1.
40. E. W. Dunn and G. W. Coates, J. Am. Chem. Soc., 2010, 132, 11412-11413.
41. M. Allmendinger, R. Eberhardt, G. Luinstra and B. Rieger, J. Am. Chem. Soc., 2002, 124, 5646-5647.
42. H.-H. Görtz, G. Luinstra, M. Allmendinger and B. Rieger, 2003, DE 10137045 A1.
43. X. Tang and E. Y. Chen, Nat. Commun., 2018, 9, 2345.
44. X. Tang, A. H. Westlie, E. M. Watson and E. Y.-X. Chen, Science, 2019, 366, 754-758.
45. A. H. Westlie and E. Y. X. Chen, Macromolecules, 2020, 53, 9906-9915.
46. X. Tang, A. H. Westlie, L. Caporaso, L. Cavallo, L. Falivene and E. Y. Chen, Angew. Chem. Int. Ed., 2020, 59, 7881-7890.
47. X. Tang and E. Y. Chen, 2019, US 2019/0211144 A1.
48. X. Tang and E. Y. Chen, 2021, US 2021/0206912 A1.
49. R. Ligny, M. M. Hanninen, S. M. Guillaume and J. F. Carpentier, Angew. Chem. Int. Ed., 2017, 56, 10388-10393.
50. E. Y. Tshuva, N. Gendeziuk and M. Kol, Tetrahedron Lett., 2001, 42, 6405-6407.
51. J. Balsells, P. J. Carroll and P. J. Walsh, Inorg. Chem., 2001, 40, 5568-5574.
52. D. M. P. Mingos and R. H. Crabtree, Comprehensive Organometallic Chemistry III, Elsevier Ltd., 2007.
53. E. C. Constable, G. Parkin and L. Que Jr, Comprehensive Coordination Chemistry III, Elsevier Ltd., 2021.
54. J. C. Pessoa and I. Correia, Coord. Chem. Rev., 2019, 388, 227-247.
55. J.-F. Carpentier, Organometallics, 2015, 34, 4175-4189.
56. F. Ortu, Chem Rev, 2022, DOI: 10.1021/acs.chemrev.1c00842.
57. R. Anwander, O. Runte, J. Eppinger, G. Gerstberger, E. Herdtweck and M. Spiegler, J. Chem. Soc., Dalton Trans., 1998, 847-858.
58. D. Lowicki, J. Watral, M. Jelecki, W. Bohusz and M. Kwit, Tetrahedron, 2021, 86, 132085.

1. A chelate complex comprising:
a) a rare earth metal cation M;
b) a chelate ligand of formula (CL1A) or (CL1B) 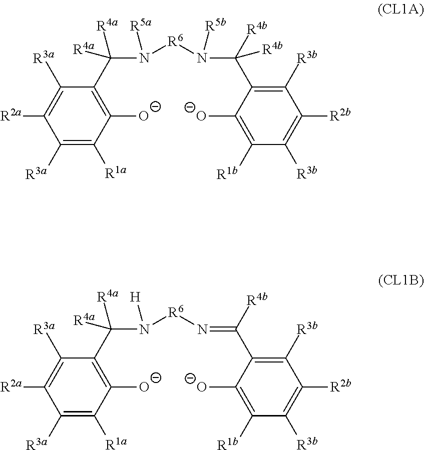
wherein
the chelate ligand is coordinated via the two nitrogen atoms and the two oxygen atoms shown in the formulae to the rare earth metal cation,
R^{1a} and R^{1b} independently represent a sterically demanding group comprising 6 or more skeleton atoms, and optionally, R^{1a} and R^{1b} may be linked to each other to provide a divalent organic residue,
R^{2a} and R^{2b} are independently selected from hydrogen, C1-C20 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} where R^{S9} and R^{S10} are independently selected from C1-C5 alkyl, a group of the formula (S-1) 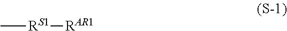
wherein R^{S1} is selected from a C1-C9 divalent alkyl group which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted, and
a group of the formula (S-2) 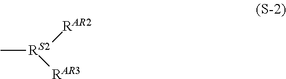
wherein R^{S2} is selected from a C1-C6 trivalent alkyl group which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted,
R^{3a} and R^{3b} are, independently for each occurrence, selected from hydrogen, C1-C10 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} where R^{S9} and R^{S10} are independently selected from C1-C5 alkyl,
R^{4a} and R^{4b} are selected, independently for each occurrence, from hydrogen, C1-C3 alkyl, halogen, —NO₂, —CN, C1-C3 haloalkyl and C1-C3 alkoxy,
R^{5a} and R^{5b} are independently selected from hydrogen, alkyl, cycloalkyl and phenyl, with the proviso that one of R^{5a} and R^{5b} must be hydrogen,
R⁶ is selected from a C2-C5 alkanediyl, a C2-C5 alkenediyl and a C2-C5 alkynediyl group, wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} where R^{S9} and R^{S10} are independently selected from C1-C5 alkyl, and/or
two substituents R^{S11} may be linked to form, together with the atoms to which they are attached, a 5 to 14 membered carbocyclic or heterocyclic group which is optionally substituted by one or more further substituents;
c) at least one anionic nucleophilic ligand L^{N} which is coordinated as a further ligand to the rare earth metal cation; and
d) optionally one or more neutral donor ligands L^{D} coordinated as ligands to the rare earth metal cation.

2. The chelate complex in accordance with claim 1, wherein the rare earth metal cation is selected from Y³⁺, Yb³⁺, La³⁺ and Lu³⁺.

3. The chelate complex in accordance with claim 1, wherein R^{1a} and R^{1b} are independently selected from (i) to (iii)
(i) a branched C6 to C15 alkyl group or a branched C6 to C15 alkoxy group comprising at least one of a tertiary and a quaternary carbon atom, which branched alkyl group and branched alkoxy group is optionally substituted,
(ii) a group of the formula (S-1): 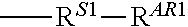
wherein R^{S1} is selected from a C1-C9 divalent alkyl group which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted;
(iii) a group of the formula (S-2) 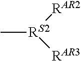
wherein R^{S2} is selected from a C1-C6 trivalent alkyl group which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted.

4. The chelate complex in accordance with claim 1, wherein the anionic nucleophilic ligand L^{N} is selected from a halogen ligand, a hydrocarbyl ligand, an α-silylalkyl ligand, an amide ligand, a silylamide ligand, an alkoxide ligand, an aryloxide ligand, a borohydride (BH₄⁻) ligand, NO₃⁻, a carboxylate ligand, a thiolate ligand, a sulfate ligand, and a sulfonate ligand.

5. The chelate complex in accordance with claim 1, which is a complex of the following formula (K1A) or (K1B): 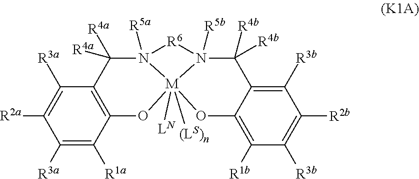
wherein
R^{1a}, R^{1b}, R^{2a}, R^{2b}, R^{3a}, R^{3b}, R^{4a}, R^{4b}, R^{5a}, R^{5b} and R⁶ are defined as in the preceding claims,
M is a rare earth metal cation,
L^{N} is an anionic nucleophilic ligand,
L^{S} is a neutral donor ligand that is a neutral solvent ligand, and n is 0, 1 or 2; 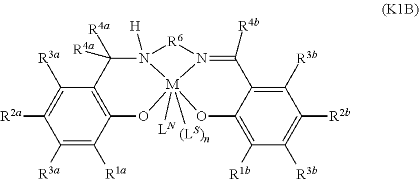
wherein
R^{1a}, R^{1b}, R^{2a}, R^{2b}, R^{3a}, R^{3b}, R^{4a}, R^{4b} and R⁶ are defined as in the preceding claims,
M is a rare earth metal cation,
L^{N} is an anionic nucleophilic ligand
L^{S} is a neutral donor ligand that is a neutral solvent ligand, and n is 0, 1 or 2.

6. A process for the preparation of a chelate complex which comprises a step of reacting a rare earth metal precursor comprising a rare earth metal cation M with one of b1 or b2
b1) a pro-ligand of formula (PL1A) or a deprotonated form thereof from which the protons of the phenolic hydroxyl groups shown in formula (PL1A) are removed: 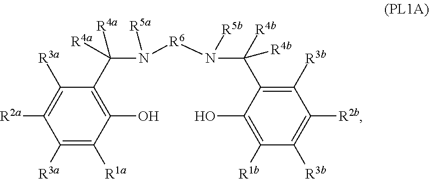
b2) a pro-ligand of formula (PL1B) or a deprotonated form thereof from which the protons of the phenolic hydroxyl groups shown in formula (PL1B) are removed: 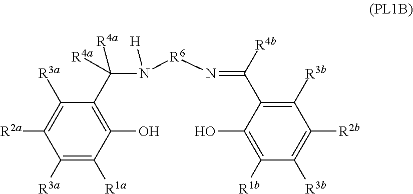
wherein, in formulae (PL1A) and (PL1B),
R^{1a} and R^{1b} independently represent a sterically demanding group comprising 6 or more skeleton atoms, and optionally, R^{1a} and R^{1b} may be linked to each other to provide a divalent organic residue,
R^{2a} and R^{2b} are independently selected from hydrogen, C1-C20 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, —NR^{S9}R^{S10} where R^{S9} and R^{S10} are independently selected from C1-C5 alkyl, a group of the formula (S-1) 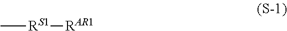
wherein R^{S1} is selected from a C1-C9 divalent alkyl group which is optionally substituted, —O— and a —O—C1-C8 divalent alkyl group which is optionally substituted, and R^{AR1} is selected from a phenyl group which is optionally substituted and a 5- to 6-membered heteroaryl group which is optionally substituted, and
a group of the formula (S-2) 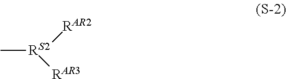
wherein R^{S2} is selected from a C1-C6 trivalent alkyl group which is optionally substituted, —O— and a —O—C1-C5 trivalent alkyl group which is optionally substituted, and R^{AR2} and R^{AR3} are independently selected from a phenyl group which is optionally substituted and a 5- to 6-membered heteroaryl group which is optionally substituted,
R^{3a} and R^{3b} are, independently for each occurrence, selected from hydrogen, C1-C10 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 10 membered aryl group which is optionally substituted, a 5 to 10 membered heteroaryl group which is optionally substituted, and —NR^{S9}R^{S10} where R^{S9} and R^{S10} are independently selected from C1-C5 alkyl,
R^{4a} and R^{4b} are selected, independently for each occurrence, from hydrogen, C1-C3 alkyl, halogen, —NO₂, —CN, C1-C3 haloalkyl and C1-C3 alkoxy,
R^{5a} and R^{5b} are independently selected from hydrogen, alkyl, cycloalkyl and phenyl, with the proviso that one of R^{5a} and R^{5b} must be hydrogen,
R⁶ is selected from a C2-C5 alkanediyl, a C2-C5 alkenediyl and a C2-C5 alkynediyl group,
wherein, in the alkanediyl, alkenediyl and alkynediyl group 1 or 2 carbon atoms may be replaced with a heteroatom selected from O and N,
and wherein any hydrogen atom in the alkanediyl, alkenediyl and alkynediyl group may be replaced by a substituent R^{S11}, wherein R^{S11} is selected, independently for each occurrence, from C1-C20 alkyl, halogen, —NO₂, —CN, C1-C10 haloalkyl, C1-C10 alkoxy, aryloxy with a 6 to 10 membered aryl group which is optionally substituted, heteroaryloxy with a 5 to 10 membered heteroaryl group which is optionally substituted, C2-C5 alkenyl, C2-C5 alkynyl, a 6 to 13 membered aryl group which is optionally substituted, a 5 to 10 membered heteroaryl group which is optionally substituted, and —NR^{S9}R^{S10} where R^{S9} and R^{S10} are independently selected from C1-C5 alkyl,
and/or two substituents R^{S11} may be linked to form, together with the atoms to which they are attached, a 5 to 14 membered carbocyclic or heterocyclic group which is optionally substituted by one or more further substituents;
to form a chelate complex.

7. The process of claim 6, wherein the rare earth metal precursor comprising a rare earth metal cation M is a precursor complex of formula (PK1): 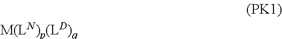
wherein
M is a rare earth metal cation,
p is an integer which corresponds to the valence of the cation M,
q is 1 to 4,
L^{N} is an anionic nucleophilic ligand, and
L^{D} is a neutral donor ligand.

8. A process for the preparation of a polymer, comprising a step of contacting monomers comprising chiral cyclic ester monomers with a chelate complex in accordance with claim 1 to allow a polymerization reaction of the monomers to proceed.

9. The process for the preparation of a polymer in accordance with claim 8, which comprises
a step of reacting, in a suitable solvent,
a) a precursor complex of the rare earth metal cation of formula (PK1) 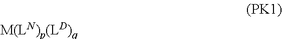
wherein
M is a rare earth metal cation,
p is an integer which corresponds to the valence of the cation M,
q is 1 to 4,
L^{N} is an anionic nucleophilic ligand, and
L^{D} is a neutral donor ligand,
with one of b1 or b2
b1) a pro-ligand of formula (PL1A) or a deprotonated form thereof from which the protons of the phenolic hydroxyl groups shown in formula (PL1A) are removed: 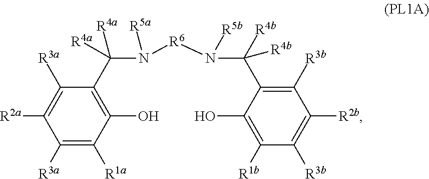
b2) a pro-ligand of formula (PL1B) or a deprotonated form thereof from which the protons of the phenolic hydroxyl groups shown in formula (PL1B) are removed: 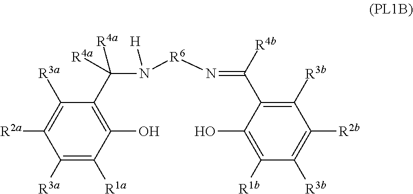
wherein in formulae (PL1A) and (PL1B) R^{1a}, R^{1b}, R^{2a}, R^{2b}, R^{3a}, R^{3b}, R^{4a}, R^{4b}, R^{5a}, R^{5b} and R⁶ are defined as in claim 6,
to form a chelate complex,
and a step of contacting monomers comprising chiral cyclic ester monomers with the formed chelate complex without prior isolation of the chelate complex,
to allow a polymerization reaction of the monomers to proceed.

10. The process in accordance with claim 6, wherein the rare earth metal cation M is selected from Y³⁺, Yb³⁺, La³⁺ and Lu³⁺.

11. The process for the preparation of a polymer in accordance with claim 8, wherein the monomers comprise chiral cyclic ester monomers of formula (M1), (M2) or (M3), or a mixture thereof: 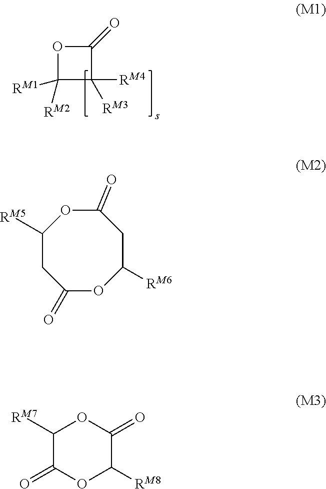
wherein:
R^{M1} to R^{M8} are independently selected from hydrogen and C1-C6 alkyl, with the proviso that R^{M1}, R^{M2} and, if present, R^{M3} and R^{M4} in formula (M1) are selected such that the monomer of formula (M1) contains at least one chiral carbon atom, that R^{M5} and R^{M6} in formula (M2) are selected such that the monomer of formula (M2) contains at least one chiral carbon atom and R^{M7} and R^{M8} in formula (M3) are selected such that the monomer of formula (M3) contains at least one chiral carbon atom,
and the variables is 1, 2, 3 or 4.

12. The process for the preparation of a polymer in accordance with claim 8, wherein the monomers comprise racemic β-butyrolactone.

13. The process for the preparation of a polymer in accordance with claim 8, wherein the polymer is poly(3-hydroxybutyrate).

14. (canceled)

15. Poly(3-hydroxybutyrate), having an isotacticity Pₘ in the range of 0.78 to 0.92, a number average molecular weight Mₙ of 12 kg mol⁻¹ or more, and a polydispersity index PDI of 1.5-3.5.

16. The process of claim 7, wherein L^{D} is a solvent ligand L^{S}.

17. The process of claim 9, wherein L^{D} is a solvent ligand L^{S}.

18. A process for the preparation of a polymer, comprising a step of contacting monomers comprising chiral cyclic ester monomers with a chelate complex obtainable by the process in accordance with claim 6 to allow a polymerization reaction of the monomers to proceed.

19. The process for the preparation of a polymer in accordance with claim 18, wherein the monomers comprise chiral cyclic ester monomers of formula (M1), (M2) or (M3), or a mixture thereof: 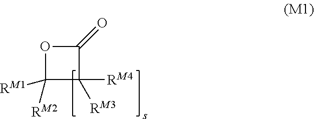 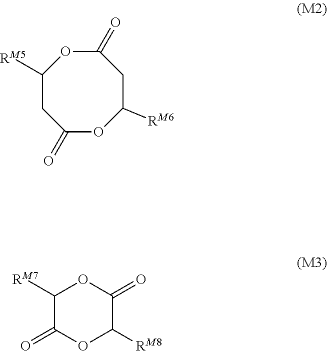
wherein:
R^{M1} to R^{M8} are independently selected from hydrogen and C1-C6 alkyl, with the proviso that R^{M1}, R^{M2} and, if present, R^{M3} and R^{M4} in formula (M1) are selected such that the monomer of formula (M1) contains at least one chiral carbon atom, that R^{M5} and R^{M6} in formula (M2) are selected such that the monomer of formula (M2) contains at least one chiral carbon atom and R^{M7} and R^{M8} in formula (M3) are selected such that the monomer of formula (M3) contains at least one chiral carbon atom,
and the variables is 1, 2, 3 or 4.

20. The process for the preparation of a polymer in accordance with claim 18, wherein the monomers comprise racemic β-butyrolactone.

21. The process for the preparation of a polymer in accordance with claim 18, wherein the polymer is poly(3-hydroxybutyrate).
